(19) United States
(12) Patent Application Publication
(10) Pub. No.: US 2026/0062028 A1
(43) Pub. Date: Mar. 5, 2026

(54) SENSOR DATA FILTERING FOR MACHINE LEARNING MODEL PROMPT GENERATION

(71) Applicant: Boston Dynamics, Inc., Waltham, MA (US)

(72) Inventors: Matthew Jacob Klingensmith, Somerville, MA (US); Michael James McDonald, Cambridge, MA (US); Gordon Finnie, III, Newton, MA (US); Marco da Silva, Arlington, MA (US); Amanda Gonano, Lincoln, MA (US)

(21) Appl. No.: 19/309,076

(22) Filed: Aug. 25, 2025

Related U.S. Application Data
(60) Provisional application No. 63/687,520, filed on Aug. 27, 2024.

(51) Int. Cl. B60W 50/14; G05D 1/43; G06V 20/56

(52) U.S. Cl. CPC B60W 50/14; G05D 1/43; G06V 20/56; B60W 2050/146

(57) ABSTRACT

Systems and methods are described for provision of alerts. A system can obtain sensor data associated with an environment. The system can obtain an input indicating one or more filter parameters, one or more requests, and/or one or more alert parameters. For example, the input may indicate a request, a region of the environment, a region of sensor data, etc. The system can filter the sensor data based on the one or more filter parameters to obtain a filtered portion of the sensor data. The system may generate a prompt for a machine learning model that includes the filtered portion of the sensor data, the one or more requests, and the one or more alert parameters. The system can provide the prompt to a computing system. The system can obtain a output from the computing system and can provide an alert based on the output.

### CROSS REFERENCE TO RELATED APPLICATION

This U.S. patent application claims priority under 35 U.S. C. § 119 (e) to U.S. Provisional Application No. 63/687520, filed Aug. 27, 2024, which is considered part of the disclosure of this application and is hereby incorporated by reference in its entirety.

### TECHNICAL FIELD

This disclosure relates generally to robotics, and more specifically, to systems, methods, and apparatus, including computer programs, for dynamic generation of prompts for machine learning models based on mobile robot data.

### BACKGROUND

Robotic devices can autonomously or semi-autonomously navigate environments (e.g., sites) to perform a variety of tasks or functions. The robotic devices can generate data based on navigating the environments. As robotic devices become more prevalent, there is a need to enable the robotic devices to perform actions based on that data in a dynamic manner. For example, there is a need to enable the robotic devices to perform actions, in a safe and reliable manner, based on the data.

### SUMMARY

An aspect of the present disclosure provides a method. The method may include obtaining, by data processing hardware, sensor data associated with traversal of an environment by one or more mobile robots. The method may further include obtaining, by the data processing hardware from a first computing system, an input indicating one or more filter parameters. The method may further include filtering, by the data processing hardware, the sensor data based on the input to obtain a filtered portion of the sensor data. The method may further include generating, by the data processing hardware, a prompt for a machine learning model. The prompt for the machine learning model may include the filtered portion of the sensor data. The method may further include providing, by the data processing hardware to a second computing system, the prompt for the machine learning model. The method may further include providing, by the data processing hardware to the first computing system, an alert based on an output of the second computing system. The output may include one or more responses to the prompt for the machine learning model.

In various embodiments, the sensor data may include panoramic image data.

In various embodiments, the sensor data may be associated with a mission of the one or more mobile robots.

In various embodiments, obtaining the sensor data may include obtaining the sensor data from a sensor of the one or more mobile robots.

In various embodiments, obtaining the sensor data may include obtaining a first portion of the sensor data from a first sensor of a mobile robot of the one or more mobile robots. Obtaining the sensor data may further include obtaining a second portion of the sensor data from a second sensor of the mobile robot.

In various embodiments, obtaining the sensor data may include obtaining a first portion of the sensor data from a first sensor of a first mobile robot of the one or more mobile robots. Obtaining the sensor data may further include obtaining a second portion of the sensor data from a second sensor of a second mobile robot of the one or more mobile robots.

In various embodiments, the one or more filter parameters may indicate a portion of the environment.

In various embodiments, the one or more filter parameters may indicate a point of view associated with the one or more mobile robots.

In various embodiments, the one or more filter parameters may indicate a sensor of the one or more mobile robots.

In various embodiments, the one or more filter parameters may indicate an object.

In various embodiments, the one or more filter parameters may indicate a route waypoint associated with the environment.

In various embodiments, the one or more filter parameters may indicate a pose associated with the one or more mobile robots.

In various embodiments, the one or more filter parameters may indicate a position associated with the one or more mobile robots.

In various embodiments, the one or more filter parameters may indicate a particular time period.

In various embodiments, the one or more filter parameters may indicate a mission associated with the one or more mobile robots.

In various embodiments, the one or more filter parameters may indicate a mission associated with the one or more mobile robots. The mission may be associated with one or more first mission parameters. The prompt for the machine learning model may be associated with one or more second mission parameters.

In various embodiments, the prompt for the machine learning model may further include one or more multiple choice questions.

In various embodiments, the prompt for the machine learning model may further include one or more open-ended questions.

In various embodiments, the prompt for the machine learning model may further include one or more questions requesting a comparison of at least a first image of the filtered portion of the sensor data to a second image of the filtered portion of the sensor data.

In various embodiments, the output may include at least one of a flag, a visual sorting, a visual top K, or a ranking.

In various embodiments, the prompt for the machine learning model may further include one or more questions requesting a comparison of at least a first image of the filtered portion of the sensor data to a second image of the filtered portion of the sensor data. The output may include a visual sorting of the first image and the second image.

In various embodiments, the prompt for the machine learning model may further include a prompt to provide a structured output.

In various embodiments, the prompt for the machine learning model may further include a prompt to provide a JSON file.

In various embodiments, the one or more responses may include one or more responses in JSON data format.

In various embodiments, the first computing system may include a user computing device.

In various embodiments, the second computing system may implement the machine learning model.

In various embodiments, the second computing system may be remote from the one or more mobile robots.

In various embodiments, the second computing system may be a computing system of the one or more mobile robots.

In various embodiments, the method may further include generating the alert based on the output.

In various embodiments, the method may further include transforming the output based on the prompt for the machine learning model to identify a transformed output. The method may further include generating the alert based on the transformed output.

In various embodiments, the method may further include providing the output to a database. The method may further include providing, to the first computing system, access to the database.

In various embodiments, the method may further include providing the output to a database. The method may include providing, to the first computing system, a link to the database.

In various embodiments, the method may further include providing the output to the first computing system.

In various embodiments, the method may further include determining that a value associated with the output is greater than or matches a threshold. The method may further include generating the alert based on determining that the value is greater than or matches the threshold.

In various embodiments, the method may further include generating the alert based on the output and one or more alert parameters.

In various embodiments, the method may further include determining that at least one of text associated with the output or a value associated with the output is greater than or matches a threshold. The input may include one or more alert parameters. The one or more alert parameters may indicate the threshold. The method may further include generating the alert based on determining that the at least one of the text or the value is greater than or matches the threshold.

In various embodiments, the alert may indicate a portion of the environment.

In various embodiments, the alert may be indicative of anomalous behavior.

In various embodiments, the alert may indicate a presence of an anomaly condition within the filtered portion of the sensor data.

In various embodiments, the alert may indicate a quantity of an object.

In various embodiments, the prompt for the machine learning model may indicate that the filtered portion of the sensor data is associated with the one or more mobile robots.

In various embodiments, the prompt for the machine learning model may indicate that the filtered portion of the sensor data is associated with the one or more mobile robots and each of the one or more mobile robots comprises two or more legs.

In various embodiments, the machine learning model may include a visual question answering model.

In various embodiments, the machine learning model may include an object detector.

In various embodiments, filtering the sensor data may include filtering the sensor data to remove a portion of the sensor data.

In various embodiments, the sensor data may include a plurality of images. Filtering the sensor data may include filtering the sensor data to remove an image from the plurality of images.

In various embodiments, the sensor data may include a plurality of images. Filtering the sensor data may include filtering the sensor data to remove a portion of an image of the plurality of images.

In various embodiments, the method may further include instructing the one or more mobile robots to obtain the sensor data.

In various embodiments, the method may further include instructing the one or more mobile robots to obtain the sensor data based on obtaining the input.

In various embodiments, the method may further include instructing performance of one or more actions based on the output.

In various embodiments, the method may further include instructing performance of one or more actions by the one or more mobile robots based on the output.

In various embodiments, the method may further include instructing performance of one or more actions by a mobile robot based on the output.

In various embodiments, the method may further include instructing display of a user interface based on the output. The user interface may indicate the alert.

In various embodiments, the one or more mobile robots may include one or more quadruped robots.

According to various embodiments of the present disclosure, a system may include data processing hardware and memory in communication with the data processing hardware. The memory may store instructions that when executed on the data processing hardware cause the data processing hardware to obtain sensor data associated with traversal of an environment by one or more mobile robots. Execution of the instructions may further cause the data processing hardware to obtain, from a first computing system, an input indicating one or more filter parameters. Execution of the instructions may further cause the data processing hardware to filter the sensor data based on the input to obtain a filtered portion of the sensor data. Execution of the instructions may further cause the data processing hardware to generate a prompt for a machine learning model. The prompt for the machine learning model may include the filtered portion of the sensor data. Execution of the instructions may further cause the data processing hardware to provide, to a second computing system, the prompt for the machine learning model. Execution of the instructions may further cause the data processing hardware to provide, to the first computing system, an alert based on an output of the second computing system. The output may include one or more responses to the prompt for the machine learning model.

In various embodiments, the system may further include any combination of the features discussed herein.

According to various embodiments of the present disclosure, a mobile robot may include data processing hardware and memory in communication with the data processing hardware. The memory may store instructions that when executed on the data processing hardware cause the data processing hardware to obtain sensor data associated with traversal of an environment by one or more mobile robots. Execution of the instructions may further cause the data processing hardware to obtain, from a first computing system, an input indicating one or more filter parameters. Execution of the instructions may further cause the data processing hardware to filter the sensor data based on the input to obtain a filtered portion of the sensor data. Execution of the instructions may further cause the data processing hardware to generate a prompt for a machine learning model. The prompt for the machine learning model may include the filtered portion of the sensor data. Execution of the instructions may further cause the data processing hardware to provide, to a second computing system, the prompt for the machine learning model. Execution of the instructions may further cause the data processing hardware to provide, to the first computing system, an alert based on an output of the second computing system. The output may include one or more responses to the prompt for the machine learning model.

In various embodiments, the mobile robot may further include any combination of the features discussed herein.

According to various embodiments of the present disclosure, a method may include obtaining, by data processing hardware, sensor data associated with traversal of an environment by one or more mobile robots. The method may further include obtaining, by the data processing hardware from a first computing system, an input indicating one or more filter parameters. The method may further include filtering, by the data processing hardware, the sensor data based on the input to obtain a filtered portion of the sensor data. The method may further include generating, by the data processing hardware, a prompt for a machine learning model. The prompt for the machine learning model may include the filtered portion of the sensor data. The method may further include providing, by the data processing hardware to a second computing system, the prompt for the machine learning model. The method may further include instructing, by the data processing hardware, performance of one or more actions based on an output of the second computing system.

In various embodiments, the method may further include any combination of the features discussed herein.

According to various embodiments of the present disclosure, a method may include obtaining, by data processing hardware, data associated with an environment of one or more mobile robots. The method may further include instructing, by the data processing hardware, display of a user interface via a first computing system based on the data associated with the environment. The method may further include obtaining, by the data processing hardware from the first computing system, an input indicating one or more filter parameters. The method may further include filtering, by the data processing hardware, sensor data associated with the one or more mobile robots based on the input to obtain a filtered portion of the sensor data. The method may further include generating, by the data processing hardware, a prompt for a machine learning model. The prompt for the machine learning model may include the filtered portion of the sensor data. The method may further include providing, by the data processing hardware to a second computing system, the prompt for the machine learning model. The method may further include providing, by the data processing hardware to the first computing system, an alert based on an output of the second computing system. The output may include one or more responses to the prompt for the machine learning model.

In various embodiments, the method may further include any combination of the features discussed herein.

According to various embodiments of the present disclosure, a method may include obtaining, by data processing hardware, data associated with an environment of one or more mobile robots. The method may further include instructing, by the data processing hardware, display of a user interface via a first computing system based on the data associated with the environment. The method may further include obtaining, by the data processing hardware from the first computing system, an input indicating one or more filter parameters. The method may further include instructing, by the data processing hardware, traversal of the environment by the one or more mobile robots. The method may further include obtaining, by the data processing hardware, sensor data based on the traversal of the environment by the one or more mobile robots. The method may further include filtering, by the data processing hardware, the sensor data based on the input to obtain a filtered portion of the sensor data. The method may further include generating, by the data processing hardware, a prompt for a machine learning model. The prompt for the machine learning model may include the filtered portion of the sensor data. The method may further include providing, by the data processing hardware to a second computing system, the prompt for the machine learning model. An output of the second computing system may include one or more responses to the prompt for the machine learning model.

In various embodiments, the method may further include any combination of the features discussed herein.

According to various embodiments of the present disclosure, a method may include obtaining, by data processing hardware, first sensor data associated with one or more mobile robots. The method may further include instructing, by the data processing hardware, display of a user interface via a first computing system based on the first sensor data. The method may further include obtaining, by the data processing hardware from the first computing system, an input indicating one or more filter parameters. The method may further include obtaining, by the data processing hardware, second sensor data associated with the one or more mobile robots. The method may further include filtering, by the data processing hardware, the second sensor data based on the input to obtain a filtered portion of the second sensor data. The method may further include generating, by the data processing hardware, a prompt for a machine learning model. The prompt for the machine learning model may include the filtered portion of the second sensor data. The method may further include providing, by the data processing hardware to a second computing system, the prompt for the machine learning model. An output of the second computing system may include one or more responses to the prompt for the machine learning model.

In various embodiments, the method may further include any combination of the features discussed herein.

According to various embodiments of the present disclosure, a system may include data processing hardware and memory in communication with the data processing hardware. The memory may store instructions that when executed on the data processing hardware cause the data processing hardware to perform any combination of the features discussed herein.

According to various embodiments of the present disclosure, a legged robot may include at least one sensor, at least two legs, data processing hardware, and memory in communication with the data processing hardware. The memory may store instructions that when executed on the data processing hardware cause the data processing hardware to perform any combination of the features discussed herein.

### DESCRIPTION OF DRAWINGS

FIG. 1A is a schematic view of an example robot for navigating an environment.

FIG. 1B is a schematic view of a navigation system for navigating the robot of FIG. 1A.

FIG. 2 is a schematic view of exemplary components of a navigation system of a robot.

FIG. 3 is a schematic view of a topological map.

FIG. 4 is a schematic view of an environment including plurality of systems associated with the robot of FIG. 1A.

FIG. 5A is an operation diagram illustrating a data flow for operations for filtering sensor data.

FIG. 5B is an operation diagram illustrating a data flow for operations for performing actions based on filtered sensor data.

FIG. 6A is a schematic view of a selection of a portion of an environment.

FIG. 6B is a schematic view of a selection of a portion of a navigation route.

FIG. 6C is a schematic view of a selection of a portion of sensor data.

FIG. 7 is a schematic view of a user interface for providing an input for generation of a prompt.

FIG. 8A is a schematic view of a first example of a user interface for providing an alert.

FIG. 8B is a schematic view of a second example of a user interface for providing an alert.

FIG. 8C is a schematic view of a third example of a user interface for providing an alert.

FIG. 8D is a schematic view of a fourth example of a user interface for providing an alert.

FIG. 9 is a flowchart of an example arrangement of operations for providing an alert based on a generated and implemented prompt.

FIG. 10 is a schematic view of an example computing device that may be used to implement the systems and methods described herein.

Like reference symbols in the various drawings indicate like elements.

### DETAILED DESCRIPTION

Generally described, autonomous and semi-autonomous robots (e.g., mobile robots, legged robots, etc.) can capture data (e.g., robot data, mobile robot data, etc.) associated with the robots. The data may correspond to (e.g., may represent) an environment of a robot. For example, the data may be a two-dimensional representation of a three-dimensional environment of the robot.

A robot can obtain the data (e.g., sensor data) from one or more components of the robot (e.g., sensors, sources, outputs, etc.). For example, the robot can obtain sensor data from an image sensor, a lidar sensor, a ladar sensor, a radar sensor, pressure sensor, an accelerometer, a battery sensor (e.g., a voltage meter), a speed sensor, a position sensor, an orientation sensor, a pose sensor, a tilt sensor, a clock, and/or any other component of the robot. Further, the sensor data may include image data, lidar data, ladar data, radar data, pressure data, acceleration data, battery data (e.g., voltage data), speed data, position data, orientation data, pose data, tilt data, time data, temperature data, etc. For example, the data may include image data that further includes a plurality of images. It will be understood that while reference may be made herein to sensor data or image data, any data associated with the robot can be utilized.

In some cases, the robot can capture sensor data as the robot traverses the environment. For example, the robot can capture the sensor data as the robot actively traverses the environment. In some cases, the robot can capture the sensor data before or after the robot traverses the environment. For example, the robot can traverse the environment to a first location within the environment, obtain sensor data associated with the first location, traverse the environment to a second location within the environment, obtain sensor data associated with the second location, etc.

The robot may obtain instructions to capture particular sensor data and/or navigate in a certain manner within an environment (e.g., from a user computing device). For example, the robot may receive instructions requesting performance of a particular mission. In some cases, the robot may receive the instructions as an input from a user computing device. For example, a user, via a computing device, may navigate a robot through an environment to perform one or more actions based on the instructions and/or sensor data associated with the environment.

In some cases, to obtain the instructions, the robot may obtain sensor data associated with an environment and provide (e.g., in real time) the sensor data to a user computing device (e.g., for display via a user interface). In response to the providing of the sensor data, a user, via the user interface, can identify an object, entity, structure, and/or obstacle in the environment (e.g., based on a particular portion of the sensor data) and provide instructions in response. For example, a user can select an action for performance based on data provided by the robot (e.g., data indicating a position of a lever).

The instructions received by the robot may indicate how to navigate through the environment and may indicate one or more actions to perform. For example, the one or more actions may include capturing sensor data, performing an analysis (e.g., a chemical analysis), collecting a sample, moving an object (e.g., moving a chair from a first location to a second location), etc. In some cases, the instructions may indicate a request to navigate to a portion of the environment and perform an action based on the identified object, entity, structure, and/or obstacle. For example, the sensor data may indicate the presence of a machine within the environment and the user, via the user computing device, may provide instructions to navigate to the machine and perform a thermal inspection on the machine based on the sensor data indicating the presence of the machine.

The one or more actions may be linked to a particular portion of the environment based on the instructions. For example, the instructions received by the robot may indicate that the robot is to utilize a particular pose of the robot, position of the robot, orientation of the robot, location of the robot, etc. to perform a particular action.

In some cases, the robot may record the mission (e.g., record a mission as the mission is performed by the robot) based on performance of mission. For example, the robot may record a navigation route of the mission, one or more actions performed by the robot during performance of the mission, data collected by the robot during performance of the mission (e.g., sensor data), etc. as a mission recording. The robot may store and/or output the recorded mission.

The navigation route may be indicative of the navigation by the robot. For example, the navigation route may include a set of route waypoints, a set of route edges, and one or more actions based on the actions performed by the robot (e.g., one or more actions to perform at one or more route waypoints of the set of route waypoints). All or a portion of the set of route edges may connect two or more route waypoints. In some cases, to record the navigation route, the robot may record a route waypoint periodically within the recorded mission (e.g., every minute, every five meters, every time the robot performs an action or a particular type of action, etc.).

In some cases, the robot may store the recorded mission (e.g., the navigation route and the one or more actions performed by the robot). For example, the robot may store the recorded mission in memory to enable the reimplementation of the recorded mission by the robot or another robot. By storing the recorded mission, the robot may be able to autonomously reimplement the recorded mission. For example, the robot may perform a mission (e.g., at a first time period) to navigate to a portion of the environment and read a value on a gauge based on instructions received from a computing device and may record the mission. Using the mission recording, the robot may autonomously perform the mission (e.g., at a second time period).

In some cases, the robot may obtain sensor data (e.g., based on performance of a mission) and may store the sensor data. The robot may store the sensor data in memory. For example, the robot may store the sensor data in a data bucket, a data bundle, a data store, a file, a database, etc. In some cases, the robot may store the sensor data as log data. For example, the log data may include image data, lidar data, ladar data, radar data, pressure data, acceleration data, battery data (e.g., voltage data), speed data, position data, orientation data, pose data, tilt data, time data, temperature data, etc.

In some cases, multiple robots (e.g., a fleet of robots) may record missions and/or store sensor data obtained by the robots (e.g., during performance of a first mission). For example, a first robot may record a first mission and store first sensor data and a second robot may record a second mission and store second sensor data.

In some cases, the robot may store (e.g., directly) the mission recording and/or the obtained sensor data. In some cases, the robot may provide the mission recording and/or the obtained sensor data to a computing system that may store the mission recording and/or the obtained sensor data.

In some cases, the robot may store the sensor data and/or the mission recording in real time. For example, the robot may stream the sensor data to the computing system. In some cases, the robot may not store the sensor data and/or the mission recording in real time. For example, the robot may store the mission recording after completion, finalization, verification, approval, etc. of the mission.

In some cases, the robot may receive instructions to execute a previously recorded mission (e.g., to recreate and/or reperform a previous navigation and/or previous actions performed by the robot within the environment). In response to the instructions, the robot may execute the previously recorded mission (e.g., by navigating along the navigation route and performing the one or more actions). In some cases, the robot may perform (e.g., autonomously) the previously recorded mission without explicit input from a user computing device.

As actions may be linked to particular missions and/or may be based on active navigation through an environment (e.g., by a user computing device), performing new actions and/or performing actions with respect to different portions of an environment or different sensor data may be computationally inefficient and/or power intensive. For example, a robot may autonomously perform actions (e.g., repeatedly perform an action) with respect to a same portion of an environment (e.g., based on a mission recording). However, to perform new actions and/or perform actions with respect to different portions of an environment (or a panoramic representation of the environment), a computing system may provide instructions navigating the robot through the environment and identifying particular actions for the robot to perform at particular locations within the environment.

In some cases, a user may attempt to manually define different actions. However, such a manual definition of the actions and a manual association of the actions with particular portions of an environment and/or particular sensor data may not be possible as a robot may navigate large environments and the environments may include different entities, obstacles, structures, and/or objects. Further, the movements to perform an action may be numerous such that the definition of the actions may include a large amount of data and it may not be possible to manually define the different actions in an efficient manner. Such a manual process may cause issues and/or inefficiencies (e.g., inefficiencies in mission performance) as the defined actions may be based on an erroneous interpretation of the environment. Further, such a manual process may be resource, time intensive, and inefficient based on the amount of data associated with a robot.

As components (e.g., mobile robots) proliferate, the demand for dynamic performance of actions by the computing system has increased. Specifically, the demand for robots to dynamically perform actions with respect to different portions of an environment and/or different sensor data has increased. The present disclosure provides systems and methods that enable an increase in the accuracy and/or efficiency in the performance of the actions (e.g., anomaly detection actions).

To dynamically perform the actions, the methods and apparatus described herein enable a system to dynamically generate a prompt for a machine learning model based on sensor data and an input (e.g., a user input). The system can obtain an output from another system (e.g., implementing the machine learning model) indicating performance of the action (e.g., by the system implementing the machine learning model) and may cause generation of an alert based on the performance of the action. For example, the alert may indicate that particular sensor data satisfies (e.g., is greater than, matches, is less than, or is within) a threshold (e.g., a threshold value, a threshold range, etc.) or set of two or more thresholds.

The present disclosure relates to such a dynamic implementation of actions (e.g., that can be combined with obtained sensor data). For example, the actions can be decoupled from missions such that the actions can be dynamically implemented (e.g., based on input requests) without recording an additional mission. Further, the actions can be decoupled from missions such that the robot can implement a first subset of the actions and a different system (e.g., a computing system implementing a machine learning model) can implement a second subset of the actions (e.g., monitoring sensor data for one or more anomalies). The actions can be dynamically implemented with respect to a particular portion of an environment, a particular portion of sensor data, a particular portion of mission, etc. (e.g., based on one or more filter parameters).

In some cases, the actions may include discrete mobile sensing tasks for particular sensor data (e.g., filtered sensor data). For example, the location of an anomaly may be unknown such that it may be advantageous to monitor all or a portion of the sensor data associated with all or a portion of an environment, associated with all or a portion of one or more missions, all or a portion of one or more route waypoints, all or a portion of one or more robots, all or a portion of one or more sensors, all or a portion of one or more sensors, all or a portion of one or more environmental statuses, etc. for the anomaly.

The present disclosure further relates to a computing system for prompt generation for a machine learning model based on sensor data associated with a robot (e.g., sensor data associated with a mission, sensor data associated with an environment, sensor data associated with a route waypoint, sensor data associated with a particular sensor, sensor data associated with a particular robot, sensor data associated with a particular time period, sensor data associated with a particular environmental status, sensor data associated with a particular object, entity, structure, and/or obstacle, sensor data associated with a particular pose, orientation, location, and/or position of a robot, etc.). For example, the computing system can generate a prompt for a machine learning model based on particular sensor data associated with a particular portion of an environment. The computing system can reduce the sensor data for performance of a particular action by filtering the sensor data according to one or more filter parameters.

In some cases, the computing system can obtain first sensor data associated with a robot, identify a manner of filtering the first sensor data, and filter second sensor data associated with the robot (or a different robot) based on the manner of filtering the first sensor data for generation of a prompt. For example, the computing system can (e.g., continuously) monitor first sensor data associated with a robot (e.g., for one or more anomalies) by generating prompts based on a manner of filtering identified with respect to second sensor data.

As discussed herein, the computing system can obtain sensor data, one or more mission recordings, one or more maps, etc. For example, the computing system may obtain the sensor data from one or more sensors of a robot. In another example, the computing system may obtain the one or more maps (e.g., an environmental model) from a computing system associated with the environment.

Based on the obtained sensor data, obtained one or more mission recordings, and/or obtained one or more maps, the computing system can obtain an input. The input may include one or more alert parameters, one or more filter parameters, and/or one or more requests (e.g., one or more questions) for generation of a prompt.

The one or more filter parameters may indicate a manner of filtering sensor data. For example, the one or more filter parameters may indicate a selection of all or a portion of a mission, all or a portion of an environment, all or a portion of a set of sensor data, all or a portion of one or more route waypoints, all or a portion of route edges, all or a portion of a time period, all or a portion of one or more sensors, all or a portion of one or more robots, all or a portion of one or more environmental statuses, etc. In another example, the one or more filter parameters may indicate all or a portion of a mission, all or a portion of an environment, all or a portion of the sensor data, all or a portion of one or more route waypoints, all or a portion of a time period, all or a portion of one or more sensors, all or a portion of one or more robots, all or a portion of one or more environmental statuses, all or a portion of one or more objects, entities, structures, and/or obstacles, all or a portion of one or more poses, orientations, locations, and/or positions of a robot, etc. for providing a response to one or more requests.

The one or more requests may include one or more questions associated with the filtered sensor data. For example, the one or more requests may include a question of whether a component is rusty, whether a floor is wet, whether a sensor value satisfies a threshold, etc. In another example, the one or more requests may include a request to count particular features (e.g., gauges, clocks, sensors, fire extinguishers, etc.), measure a value or percentage associated with the environment (e.g., measure a percentage of a feature that is obstructed), identify any anomalies (e.g., entities within a restricted zone, gauges with values that satisfy a threshold, etc.), etc. based on a request associated with the environment (e.g., and provided by a user via a user computing device). The one or more requests may be one or more requests to be performed on sensor data (e.g., sensor data associated with all or a portion of a mission, all or a portion of an environment, all or a portion of the sensor data, all or a portion of one or more route waypoints, all or a portion of a time period, all or a portion of one or more sensors, all or a portion of one or more robots, all or a portion of one or more environmental statuses, all or a portion of one or more objects, entities, structures, and/or obstacles, all or a portion of one or more poses, orientations, locations, and/or positions of a robot, etc.). In some cases, the one or more requests may include one or more questions in a human-readable format.

The input may further indicate one or more alert parameters (e.g., parameters for generating alerts based on the indicated action and the associated sensor data). For example, the one or more alert parameters may indicate that the computing system is to generate an alert and provide the alert (e.g., to a user computing device) if the action is performed with respect to particular sensor data and the output based on performance of the action is satisfies a threshold (e.g., an alert threshold). In another example, the one or more alert parameters may indicate that the computing system is to provide a top N portion of the sensor data, a random or pseudo-random N portion of the sensor data, an N portion of the sensor data closest to a location of the robot, etc. (e.g., a top 3 images) based on the output (e.g., the output indicating a sorting and/or a ranking), where N can be any number. In another example, the one or more alert parameters may indicate that the computing system is to treat a request as a question having a strict yes or no answer, and alert on yes. In another example, the one or more alert parameters may indicate that the computing system is to determine whether the output matches particular text (e.g., whether the output contains the text “rust,”“water,”“leak,”etc.) and alert if the output matches the particular text.

In some cases, the computing system may instruct display of the sensor data, the one or more mission recordings, the one or more maps, etc. The computing system may receive the input based on an interaction with the displayed sensor data, the displayed one or more mission recordings, the displayed one or more maps, etc.

The computing system may obtain sensor data based on the input. For example, the input may indicate a portion of an environment and the computing system may obtain sensor data associated with the portion of the environment based on the input.

In some cases, the input may indicate one or more requests for execution on historical sensor data (e.g., previously obtained sensor data). For example, the input may indicate a question to be answered with respect to sensor data previously obtained by a robot. Based on the input, the computing system may identify the sensor data as previously obtained and stored (e.g., within common storage of the computing system).

In some cases, the input may indicate one or more requests for execution on future sensor data (e.g., sensor data that has not previously been obtained). For example, the input may indicate a question to be answered with respect to sensor data obtained by a robot when a robot navigates (e.g., in the future) within the particular portion of the environment. The computing system may obtain the sensor data (e.g., in real time) as the robot navigates within the particular portion of the environment (e.g., to perform a mission). The computing system may process the sensor data to validate that the sensor data corresponds to the input (e.g., is associated with the particular portion of the environment, a particular robot, a particular sensor, a particular time period, etc.).

In some cases, the input may indicate one or more requests for execution on historical sensor data (e.g., stored historical sensor data), current sensor data (e.g., streaming sensor data), and/or future sensor data (e.g., sensor data not yet received by a robot). For example, the computing system may filter historical sensor data, current sensor data, and future sensor data (e.g., based on one or more filter parameters) and associate the filtered sensor data and the one or more requests.

Based on the input and the obtained sensor data, the computing system may generate (e.g., dynamically generate) a prompt (e.g., a text prompt) for a machine learning model. For example, the computing system may perform prompt engineering to generate the prompt. The prompt may include a portion of the sensor data (e.g., a portion of image data) and the input (e.g., one or more questions from the input).

In some cases, to generate the prompt, the computing system may include contextual data associated with the sensor data within the generated prompt. For example, the computing system may include contextual data within the generated prompt indicating that the sensor data is associated with a legged robot, is associated with one or more sensors of a legged robot directed at a floor, is associated with a robot that is operating in an environment with other robots, etc. As the machine learning model implementing the prompt may not be trained on mobile robot data, the computing system may include the contextual data to improve the effectiveness and efficiency of the machine learning model by providing context of the sensor data to the machine learning model.

The computing system may provide the generated prompt to a second computing system. The second computing system may implement a machine learning model. For example, the second computing system may implement and/or execute a visual question answering (VQA) machine learning model (e.g., a visual foundation machine learning model). In some cases, the computing system may provide, to the second computing system, the generated prompt and instructions to provide the generated prompt to the machine learning model.

In some cases, the computing system may implement and/or execute the machine learning model. For example, the computing system may implement the machine learning model (e.g., locally) and may provide the generated prompt to the machine learning model as implemented by the computing system.

In some cases, the computing system may identify data associated with the machine learning model. For example, the computing system may identify a configuration of the machine learning model indicating a format of input to the machine learning model. The computing system may generate the prompt for the machine learning model based on the identified data associated with the machine learning model. The computing system may generate the prompt for the machine learning model in a format such that the prompt is readable by the machine learning model. For example, the computing system may generate the prompt according to a particular computing language or data format.

Based on providing the prompt for the machine learning model to the machine learning model and/or to the second computing system, the computing system may obtain an output of the machine learning model (e.g., from the second computing system). In some cases, the computing system may obtain an output of the second computing system.

The output may include a response to the requests as indicated by the input. For example, the output may include image data, text data, log data, etc. In some cases, the output may include and/or may be indicative of a portion of the sensor data included within the generated prompt.

The computing system may obtain the output of the machine learning model and perform one or more actions (e.g., one or more actions) based on the output. The actions may be referred to herein as output actions, however, any actions may be performed. In some cases, the one or more output actions may include routing the output, generating and/or routing an alert, and/or instructing display of the output. For example, the computing system may route the output to a data store (e.g., a data base, a user computing device, etc.). In some cases, the one or more output actions may include instructing movement of a robot based on the output (e.g., instructing movement of one or more legs, an arm, etc. of the robot). In some cases, the one or more output actions may include instructing a robot to obtain sensor data based on the output.

In some cases, the one or more output actions may include training and/or validating a system based on the output. For example, the output may indicate that the sensor data was flagged as including an object, entity, obstacle, and/or structure (e.g., that may not have been detected by a second machine learning model) and the computing system may train a second machine learning model based on the output.

In some cases, the one or more output actions may include generating a second output based on the output. For example, the output may include a portion of the sensor data and the computing system may generate a second output (e.g., a visual representation of an environment, a graph, etc.) based on the portion of the sensor data.

In some cases, the computing system may compare the output to the one or more alert parameters (e.g., as indicated by the input). Based on comparing the output to the one or more alert parameters, the computing system may generate an alert. The computing system may route the alert based on the one or more alert parameters. For example, the computing system may route the alert to a user computing device based on the one or more alert parameters indicating to route the alert to the user computing device.

In some cases, the computing system may generate the prompt based on the one or more alert parameters. For example, the prompt may include the one or more alert parameters. The computing system may obtain the output (e.g., indicative of an alert) and the computing system may route the alert (or the output) to a user computing device based on the output.

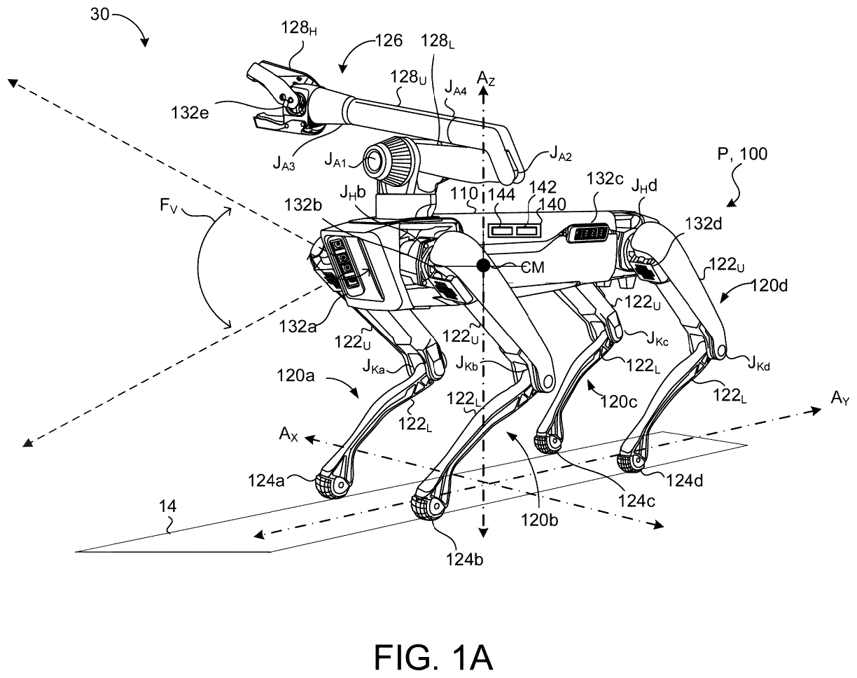

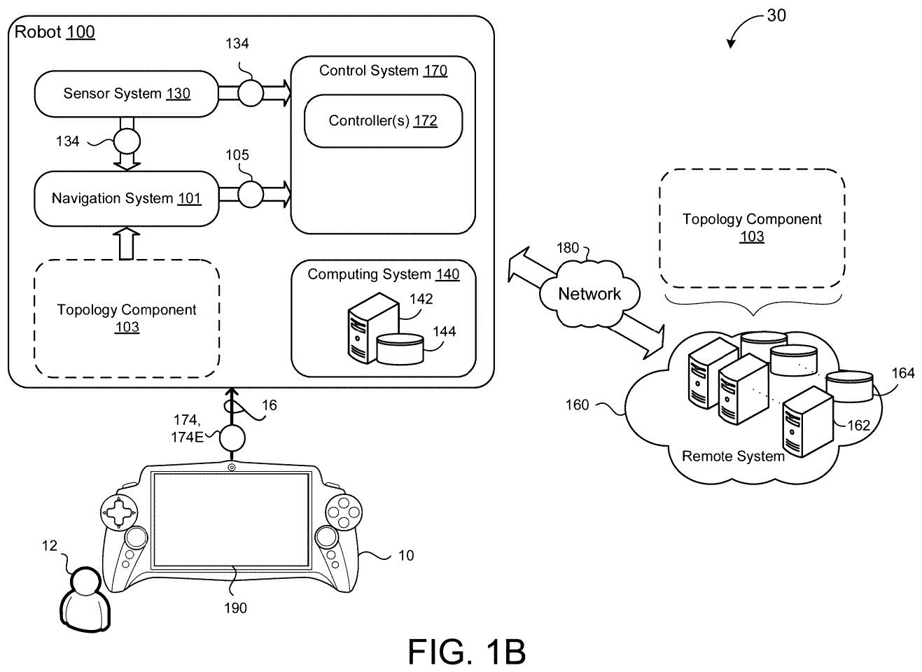

Referring to FIGS. 1A and 1B, in some implementations, a robot 100 includes a body 110 with one or more locomotion-based structures such as the first leg 120a (e.g., a stance leg), the second leg 120b, the third leg 120c, and the fourth leg 120d coupled to the body 110 that enable the robot 100 to move within an environment 30 that surrounds the robot 100. In some examples, all or a portion of the first leg 120a, the second leg 120b, the third leg 120c, and the fourth leg 120d are an articulable structure such that one or more joints J permit members of the respective leg to move. For instance, in the illustrated embodiment, all or a portion of the first leg 120a, the second leg 120b, the third leg 120c, and the fourth leg 120d include a hip joint J_{H} coupling an upper member 122_{U} of the respective leg to the body 110 and a knee joint J_{K} coupling the upper member 122_{U} of the respective leg to a lower member 122_{L} of the respective leg. Although FIG. 1A depicts a quadruped robot with four legs, the robot 100 may include any number of legs or locomotive based structures (e.g., a biped or humanoid robot with two legs, or other arrangements of one or more legs) that provide a means to traverse the terrain within the environment 30.

In order to traverse the terrain, the first leg 120a has a distal end 124a, the second leg 120b has a distal end 124b, the third leg 120c has a distal end 124c, and the fourth leg 120d has a distal end 124d. All or a portion of the distal ends may contact a surface of the terrain (e.g., a traction surface). In other words, a respective distal end of a respective leg may be the end of the respective leg used by the robot 100 to pivot, plant, or generally provide traction during movement of the robot 100. For example, the distal end of a leg may correspond to a foot of the robot 100. In some examples, though not shown, the distal end of the leg includes an ankle joint such that the distal end is articulable with respect to the lower member 122_{L} of the leg.

In the examples shown, the robot 100 includes an arm 126 that functions as a robotic manipulator. The arm 126 may move about multiple degrees of freedom in order to engage elements of the environment 30 (e.g., objects within the environment 30). In some examples, the arm 126 includes one or more members, where the members are coupled by joints J such that the arm 126 may pivot or rotate about the joint(s) J. For instance, with more than one member, the arm 126 may extend or retract. To illustrate an example, FIG. 1A depicts the arm 126 with three members corresponding to a lower member 128_{L}, an upper member 128_{U}, and a hand member 128_{H} (also referred to as an end-effector). Here, the lower member 128_{L} may rotate or pivot about a first arm joint J_{A1} located adjacent to the body 110 (e.g., where the arm 126 connects to the body 110 of the robot 100). The lower member 128_{L} is coupled to the upper member 128_{U} at a second arm joint J_{A2} and the upper member 128_{U} is coupled to the hand member 128_{H} at a third arm joint J_{A3}. In some examples, such as FIG. 1A, the hand member 128_{H} is a mechanical gripper that includes a moveable jaw and a fixed jaw may perform different types of grasping of elements within the environment 30. In the example shown, the hand member 128_{H} includes a fixed first jaw and a moveable second jaw that grasps objects by clamping the object between the jaws. The moveable jaw may move relative to the fixed jaw to move between an open position for the gripper and a closed position for the gripper (e.g., closed around an object). In some implementations, the arm 126 additionally includes a fourth joint J_{A4}. The fourth joint J_{A4} may be located near the coupling of the lower member 128_{L} to the upper member 128_{U} and function to allow the upper member 128_{U} to twist or rotate relative to the lower member 128_{L}. In other words, the fourth joint J_{A4} may function as a twist joint similarly to the third joint J_{A3} or wrist joint of the arm 126 adjacent the hand member 128_{H}. For instance, as a twist joint, one member coupled at the joint J may move or rotate relative to another member coupled at the joint J (e.g., a first member coupled at the twist joint is fixed while the second member coupled at the twist joint rotates). In some implementations, the arm 126 connects to the robot 100 at a socket on the body 110 of the robot 100. In some configurations, the socket is configured as a connector such that the arm 126 attaches or detaches from the robot 100 depending on whether the arm 126 is desired for particular operations.

The robot 100 has a vertical gravitational axis (e.g., shown as a Z-direction axis A_{Z}) along a direction of gravity, and a center of mass CM, which is a position that corresponds to an average position of all parts of the robot 100 where the parts are weighted according to their masses (e.g., a point where the weighted relative position of the distributed mass of the robot 100 sums to zero). The robot 100 further has a pose P based on the CM relative to the vertical gravitational axis A_{Z} (e.g., the fixed reference frame with respect to gravity) to define a particular attitude or stance assumed by the robot 100. The attitude of the robot 100 can be defined by an orientation or an angular position of the robot 100 in space. Movement by the first leg 120a, the second leg 120b, the third leg 120c, and the fourth leg 120d relative to the body 110 alters the pose P of the robot 100 (e.g., the combination of the position of the CM of the robot and the attitude or orientation of the robot 100). Here, a height generally refers to a distance along the z-direction (e.g., along a z-direction axis A_{Z}). The sagittal plane of the robot 100 corresponds to the Y-Z plane extending in directions of a y-direction axis A_{Y} and the z-direction axis A_{Z}. In other words, the sagittal plane bisects the robot 100 into a left and a right side. Generally perpendicular to the sagittal plane, a ground plane (also referred to as a transverse plane) spans the X-Y plane by extending in directions of the x-direction axis A_{X} and the y-direction axis A_{Y}. The ground plane refers to a ground surface 14 where distal ends of the first leg 120a, the second leg 120b, the third leg 120c, and the fourth leg 120d of the robot 100 may generate traction to help the robot 100 move within the environment 30. Another anatomical plane of the robot 100 is the frontal plane that extends across the body 110 of the robot 100 (e.g., from a right side of the robot 100 with a first leg 120a to a left side of the robot 100 with a second leg 120b). The frontal plane spans the X-Z plane by extending in directions of the x-direction axis A_{X} and the z-direction axis A_{Z}.

In order to maneuver within the environment 30 or to perform tasks using the arm 126, the robot 100 includes a sensor system with one or more sensors. For example, FIG. 1A illustrates a first sensor 132a mounted at a head of the robot 100 (near a front portion of the robot 100 adjacent the first leg 120a and the second leg 120b), a second sensor 132b mounted near the hip J_{H}b of the second leg 120b of the robot 100, a third sensor 132c mounted on a side of the body 110 of the robot 100, a fourth sensor 132d mounted near the hip J_{H}d of the fourth leg 120d of the robot 100, and a fifth sensor 132e mounted at or near the hand member 128_{H} of the arm 126 of the robot 100. The sensors may include vision/image sensors, inertial sensors (e.g., an inertial measurement unit (IMU)), force sensors, and/or kinematic sensors. For example, the sensors may include one or more of a camera (e.g., a stereo camera), a time-of-flight (TOF) sensor, a scanning light-detection and ranging (lidar) sensor, or a scanning laser-detection and ranging (ladar) sensor. In some examples, all or a portion of the sensors may have a corresponding field(s) of view F_{V} defining a sensing range or region corresponding to the sensor. For instance, FIG. 1A depicts a field of a view F_{V} for the first sensor 132a of the robot 100. All or a portion of the sensors may be pivotable and/or rotatable such that the sensor, for example, changes the field of view F_{V} about one or more axes (e.g., an x-axis, a y-axis, or a z-axis in relation to a ground plane). In some examples, multiple sensors may be clustered together (e.g., similar to the first sensor 132a) to stitch a larger field of view F_{V} than any single sensor. With multiple sensors placed about the robot 100, the sensor system may have a 360 degree view of the surroundings of the robot 100 about vertical and/or horizontal axes. In some cases, the sensor system may have less than a 360 degree view (e.g., a 340 degree view).

When surveying a field of view F_{V} with a sensor, the sensor system generates sensor data 134 (e.g., image data) corresponding to the field of view F_{V} (see, e.g., FIG. 1B). The sensor system may generate the field of view F_{V} with a sensor mounted on or near the body 110 of the robot 100 (e.g., the first sensor 132a, the third sensor 132c, etc.). The sensor system may additionally and/or alternatively generate the field of view F_{V} with the fifth sensor 132e mounted at or near the hand member 128_{H} of the arm 126. The one or more sensors capture the sensor data 134 that defines the three-dimensional point cloud for the area within the environment 30 of the robot 100. In some examples, the sensor data 134 is image data that corresponds to a three-dimensional volumetric point cloud generated by a three-dimensional volumetric image sensor. Additionally or alternatively, when the robot 100 is maneuvering within the environment 30, the sensor system gathers pose data for the robot 100 that includes inertial measurement data (e.g., measured by an IMU). In some examples, the pose data includes kinematic data and/or orientation data about the robot 100, for instance, kinematic data and/or orientation data about joints J or other portions of a leg or arm 126 of the robot 100. With the sensor data 134, various systems of the robot 100 may use the sensor data 134 to define a current state of the robot 100 (e.g., of the kinematics of the robot 100) and/or a current state of the environment 30 of the robot 100. In other words, the sensor system may communicate the sensor data 134 from one or more sensors to any other system of the robot 100 in order to assist the functionality of that system.

In some implementations, the sensor system includes sensor(s) coupled to a joint J. Moreover, these sensors may couple to a motor M that operates a joint J of the robot 100. Here, these sensors may generate joint dynamics in the form of joint-based sensor data. Joint dynamics collected as the sensor data 134 (e.g., joint-based sensor data) may include joint angles (e.g., an upper member 122_{U} relative to a lower member 122_{L} or hand member 126_{H} relative to another member of the arm 126 or robot 100), joint speed, joint angular velocity, joint angular acceleration, and/or forces experienced at a joint J (also referred to as joint forces). Joint-based sensor data generated by one or more sensors may be raw sensor data, data that is further processed to form different types of joint dynamics, or some combination of both. For instance, a sensor may measure joint position (or a position of member(s) coupled at a joint J) and systems of the robot 100 perform further processing to derive velocity and/or acceleration from the positional data. In other examples, a sensor may measure velocity and/or acceleration directly.

With reference to FIG. 1B, the sensor system 130 of the robot 100 gathers sensor data 134, a computing system 140 stores, processes, and/or to communicates the sensor data 134 to various systems of the robot 100 (e.g., the control system 170, a navigation system 101, a topology component 103, and/or remote controller 10). For example, the sensor system 130 may include the first sensor 132a, the second sensor 132b, the third sensor 132c, the fourth sensor 132d, the fifth sensor 132e, etc. In order to perform computing tasks related to the sensor data 134, the computing system 140 of the robot 100 includes data processing hardware 142 and memory hardware 144. The data processing hardware 142 may execute instructions stored in the memory hardware 144 to perform computing tasks related to activities (e.g., movement and/or movement based activities) for the robot 100. Generally speaking, the computing system 140 refers to one or more locations of data processing hardware 142 and/or memory hardware 144.

In some examples, the computing system 140 is a local system located on the robot 100. When located on the robot 100, the computing system 140 may be centralized (e.g., in a single location/area on the robot 100, for example, the body 110 of the robot 100), decentralized (e.g., located at various locations about the robot 100), or a hybrid combination of both (e.g., including a majority of centralized hardware and a minority of decentralized hardware). To illustrate some differences, a decentralized computing system may allow processing to occur at an activity location (e.g., at motor that moves a joint of a leg) while a centralized computing system may allow for a central processing hub that communicates to systems located at various positions on the robot 100 (e.g., communicate to the motor that moves the joint of the leg).

Additionally or alternatively, the computing system 140 includes computing resources that are located remote from the robot 100. For instance, the computing system 140 communicates via a network 180 with a remote system 160 (e.g., a remote server or a cloud-based environment). Much like the computing system 140, the remote system 160 includes remote computing resources such as remote data processing hardware 162 and remote memory hardware 164. Here, sensor data 134 or other processed data (e.g., data processing locally by the computing system 140) may be stored in the remote system 160 and may be accessible to the computing system 140. In additional examples, the computing system 140 may utilize the remote data processing hardware 162 and the remote memory hardware 164 as extensions of the data processing hardware 142 and the memory hardware 144 such that resources of the computing system 140 reside on resources of the remote system 160. In some examples, the topology component 103 is executed on the data processing hardware 142 local to the robot, while in other examples, the topology component 103 is executed on the remote data processing hardware 162 that is remote from the robot 100.

In some implementations, as shown in FIG. 1B, the robot 100 includes a control system 170. The control system 170 may communicate with systems of the robot 100, such as the sensor system 130, the navigation system 101, and/or the topology component 103. For example, the navigation system 101 may provide a step plan 105 to the control system 170. The control system 170 may perform operations and other functions using hardware such as the computing system 140. The control system 170 includes at least one controller 172 that may control the robot 100. For example, the at least one controller 172 controls movement of the robot 100 to traverse the environment 30 based on input or feedback from the systems of the robot 100 (e.g., the sensor system 130 and/or the control system 170). In additional examples, the at least one controller 172 controls movement between poses and/or behaviors of the robot 100. The at least one controller 172 may be responsible for controlling movement of the arm 126 of the robot 100 in order for the arm 126 to perform various tasks using the hand member 128_{H}. For instance, the at least one controller 172 controls the hand member 128_{H} (e.g., a gripper) to manipulate an object or element in the environment 30. For example, the at least one controller 172 actuates the movable jaw in a direction towards the fixed jaw to close the gripper. In other examples, the at least one controller 172 actuates the movable jaw in a direction away from the fixed jaw to close the gripper.

The at least one controller 172 of the control system 170 may control the robot 100 by controlling movement about one or more joints J of the robot 100. In some configurations, the at least one controller 172 is software or firmware with programming logic that controls at least one joint J or a motor M which operates, or is coupled to, a joint J. A software application (a software resource) may refer to computer software that causes a computing device to perform a task. In some examples, a software application may be referred to as an “application,” an “app,” or a “program.” For instance, the at least one controller 172 controls an amount of force that is applied to a joint J (e.g., torque at a joint J). As at least one controller 172 may be programmable, the number of joints J that the at least one controller 172 controls may be scalable and/or customizable for a particular control purpose. The at least one controller 172 may control a single joint J (e.g., control a torque at a single joint J), multiple joints J, or actuation of one or more members (e.g., actuation of the hand member 128_{H}) of the robot 100. By controlling one or more joints J, actuators or motors M, the at least one controller 172 may coordinate movement for all different parts of the robot 100 (e.g., the body 110, one or more legs, the arm 126). For example, to perform a behavior with some movements, the at least one controller 172 may control movement of multiple parts of the robot 100 such as, for example, the first leg 120a and the second leg 120b, the first leg 120a, the second leg 120b, the third leg 120c, and the fourth leg 120d, or the first leg 120a and the second leg 120b combined with the arm 126. In some examples, the at least one controller 172 may be configured as an object-based controller that is set up to perform a particular behavior or set of behaviors for interacting with an interactable object.

With continued reference to FIG. 1B, an operator 12 (also referred to herein as a user or a client) may interact with the robot 100 via the remote controller 10 that communicates with the robot 100 to perform actions. For example, the operator 12 transmits commands 174 to the robot 100 (executed via the control system 170) via a wireless communication network 16. Additionally, the robot 100 may communicate with the remote controller 10 to display an image on a user interface 190 of the remote controller 10. For example, the user interface 190 may display the image that corresponds to three-dimensional field of view F_{V} of the one or more sensors of the robot 100. The image displayed on the user interface 190 of the remote controller 10 is a two-dimensional image that corresponds to the three-dimensional point cloud of sensor data 134 (e.g., field of view F_{V}) for the area within the environment 30 of the robot 100. That is, the image displayed on the user interface 190 may be a two-dimensional image representation that corresponds to the three-dimensional field of view F_{V} of the one or more sensors.

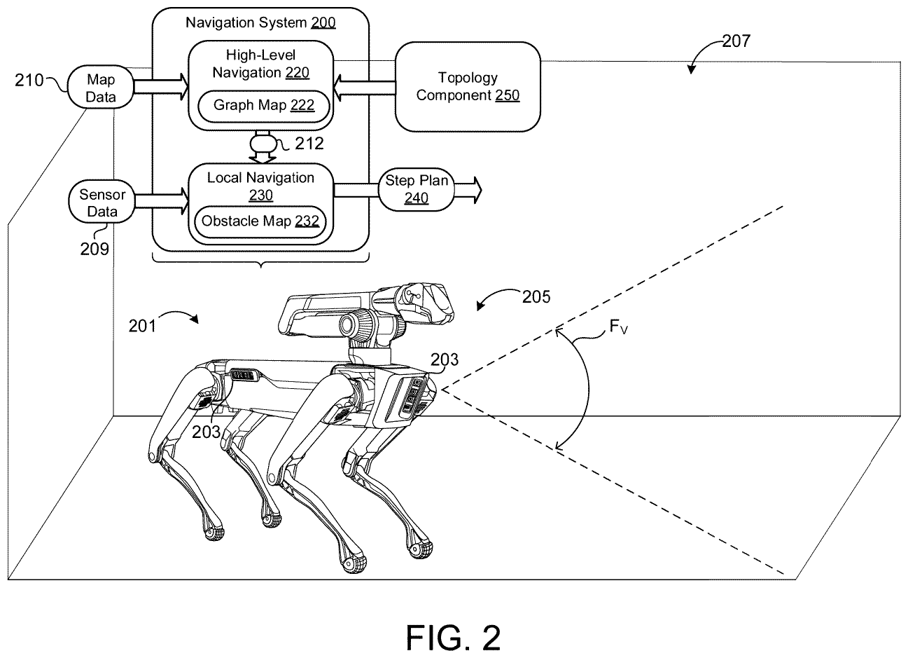

Referring now to FIG. 2, the robot 201 (e.g., the data processing hardware 142 as discussed herein with reference to FIGS. 1A and 1B) executes a navigation system 200 for enabling the robot 201 to navigate the environment 207. The sensor system 205 includes one or more sensors 203 (e.g., image sensors, lidar sensors, ladar sensors, etc.) that can each capture sensor data 209 of the environment 207 surrounding the robot 201 within the field of view F_{V}. For example, the one or more sensors 203 may be one or more cameras. The sensor system 205 may move the field of view F_{V} by adjusting an angle of view or by panning and/or tilting (either independently or via the robot 201) one or more sensors 203 to move the field of view F_{V} in any direction. In some implementations, the sensor system 205 includes a plurality of sensors (e.g., multiple cameras) such that the sensor system 205 captures a generally 360-degree field of view around the robot 201. The navigation system 200 may include and/or may be similar to the navigation system 101 discussed herein with reference to FIG. 1B, the topology component 250 may include and/or may be similar to the topology component 103 discussed herein with reference to FIG. 1B, the step plan 240 may include and/or may be similar to the step plan 105 discussed herein with reference to FIG. 1B, the robot 201 may include and/or may be similar to the robot 100 discussed herein with reference to FIGS. 1A and 1B, the one or more sensors 203 may include and/or may be similar to the one or more sensors discussed herein with reference to FIG. 1A, the sensor system 205 may include and/or may be similar to the sensor system 130 discussed herein with reference to FIG. 1B, the environment 207 may include and/or may be similar to the environment 30 discussed herein with reference to FIGS. 1A and 1B, and/or the sensor data 209 may include and/or may be similar to the sensor data 134 discussed herein with reference to FIG. 1B.

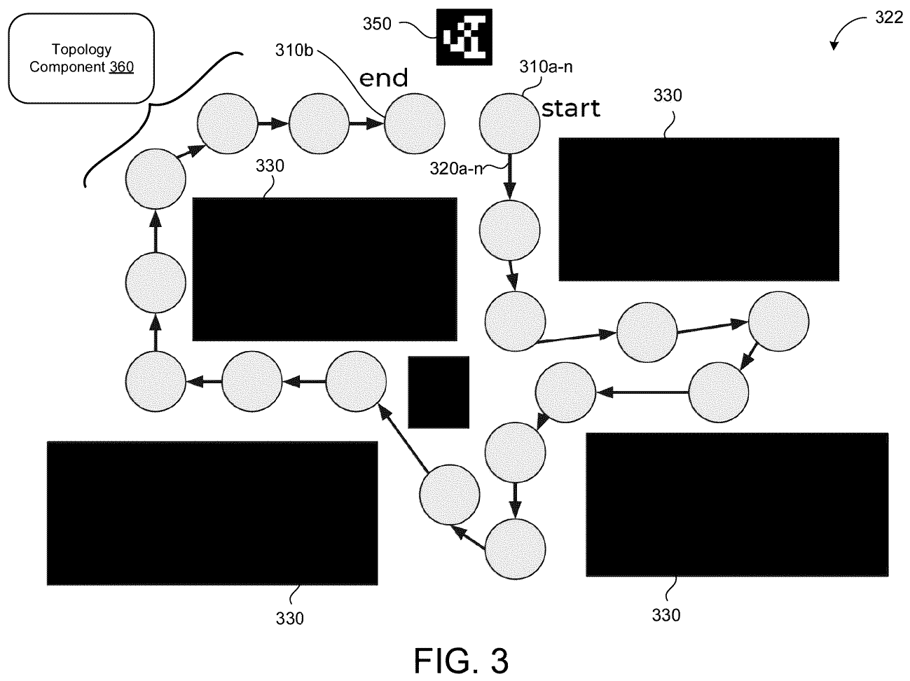

In the example of FIG. 2, the navigation system 200 includes a high-level navigation module 220 that receives map data 210 (e.g., high-level navigation data representative of locations of static obstacles in an area the robot 201 is to navigate). In some cases, the map data 210 includes a graph map 222. In other cases, the high-level navigation module 220 generates the graph map 222. The graph map 222 may include a topological map of a given area the robot 201 is to traverse. The high-level navigation module 220 can obtain (e.g., from the remote system 160 or the remote controller 10 or the topology component 250) and/or generate a series of route waypoints (as shown in FIG. 3) on the graph map 222 for a navigation route 212 that plots a path around large and/or static obstacles from a start location (e.g., the current location of the robot 201) to a destination. Route edges may connect corresponding pairs of adjacent route waypoints. In some examples, the route edges record geometric transforms between route waypoints based on odometry data (e.g., odometry data from motion sensors or image sensors to determine a change in the robot's position over time). The route waypoints and the route edges may be representative of the navigation route 212 for the robot 201 to follow from a start location to a destination location.

As discussed in more detail herein, in some examples, the high-level navigation module 220 receives the map data 210, the graph map 222, and/or an optimized graph map from a topology component 250. The topology component 250, in some examples, is part of the navigation system 200 and executed locally at or remote from the robot 201.

In some implementations, the high-level navigation module 220 produces the navigation route 212 over a greater than 10-meter scale (e.g., the navigation route 212 may include distances greater than 10 meters from the robot 201). The scale for the high-level navigation module 220 can be set based on the robot 201 design and/or the desired application, and is typically larger than the range of the one or more sensors 203. The navigation system 200 also includes a local navigation module 230 that can receive the navigation route 212 and the sensor data 209 (e.g., image data) from the sensor system 205. The local navigation module 230, using the sensor data 209, can generate an obstacle map 232. The obstacle map 232 may be a robot-centered map that maps obstacles (static and/or dynamic obstacles) in the vicinity (e.g., satisfies a threshold) of the robot 201 based on the sensor data 209. For example, while the graph map 222 may include information relating to the locations of walls of a hallway, the obstacle map 232 (populated by the sensor data 209 as the robot 201 traverses the environment 207) may include information regarding a stack of boxes placed in the hallway that were not present during the original recording. The size of the obstacle map 232 may be dependent upon both the operational range of the one or more sensors 203 and the available computational resources.

The local navigation module 230 can generate a step plan 240 (e.g., using an A* search algorithm) that plots all or a portion of the individual steps (or other movements) of the robot 201 to navigate from the current location of the robot 201 to the next route waypoint along the navigation route 212. Using the step plan 240, the robot 201 can maneuver through the environment 207. The local navigation module 230 may obtain a path for the robot 201 to the next route waypoint using an obstacle grid map based on the sensor data 209. In some examples, the local navigation module 230 operates on a range correlated with the operational range of the one or more sensors 203 (e.g., four meters) that is generally less than the scale of high-level navigation module 220.

Referring now to FIG. 3, in some examples, the topology component 360 obtains the graph map 322 (e.g., a topological map) of an environment (e.g., the environment 30 as discussed herein with reference to FIGS. 1A and 1B). For example, the topology component 360 receives the graph map 322 from a navigation system (e.g., the high-level navigation module 220 of the navigation system 200 as discussed herein with reference to FIG. 2) or generates the graph map 322 from map data (e.g., map data 210 as discussed herein with reference to FIG. 2) and/or sensor data (e.g., sensor data 134 as discussed herein with reference to FIG. 1B). The graph map 322 may be similar to and/or may include the graph map 222 discussed herein with reference to FIG. 2. The topology component 360 may be similar to and/or may include the topology component 250 discussed herein with reference to FIG. 2. The graph map 322 includes a series of route waypoints 310a-n and a series of route edges 320a-n. Each route edge in the series of route edges 320a-n topologically connects a corresponding pair of adjacent route waypoints in the series of route waypoints 310a-n. Each route edge represents a traversable route for a robot (e.g., the robot 100 as discussed herein with reference to FIGS. 1A and 1B) through an environment of the robot. The map may also include information representing one or more obstacles 330 that mark boundaries where the robot may be unable to traverse (e.g., walls and static objects). In some cases, the graph map 322 may not include information regarding the spatial relationship between route waypoints. The robot may record the series of route waypoints 310a-n and the series of route edges 320a-n using odometry data captured by the robot as the robot navigates the environment. The robot may record sensor data at all or a portion of the route waypoints such that all or a portion of the route waypoints are associated with a respective set of sensor data captured by the robot (e.g., a point cloud). In some implementations, the graph map 322 includes information related to one or more fiducial markers 350. The one or more fiducial markers 350 may correspond to an object that is placed within the field of sensing of the robot that the robot may use as a fixed point of reference. The one or more fiducial markers 350 may be any object that the robot is capable of readily recognizing, such as a fixed or stationary object of the environment or an object with a recognizable pattern. For example, a fiducial marker of the one or more fiducial markers 350 may include a bar code, QR-code, or other pattern, symbol, and/or shape for the robot to recognize.

In some cases, the robot may navigate along valid route edges and may not navigate along between route waypoints that are not linked via a valid route edge. Therefore, some route waypoints may be located (e.g., metrically, geographically, physically, etc.) within a threshold (e.g., five meters, three meters, etc.) without the graph map 322 reflecting a route edge between the route waypoints. In the example of FIG. 3, the route waypoint 310a and the route waypoint 310b are within a threshold (e.g., a threshold distance in physical space or reality), Euclidean space, Cartesian space, and/or metric space, but the robot, when navigating from the route waypoint 310a to the route waypoint 310b, may navigate the all or a portion of the series of route edges 320a-n due to the lack of a route edge directly connecting the route waypoints 310a, 310b. Therefore, the robot may determine, based on the graph map 322, that there is no direct traversable path between the route waypoints 310a, 310b. The graph map 322 may represent the route waypoints 310 in global (e.g., absolute positions) and/or local positions where positions of the route waypoints are represented in relation to one or more other route waypoints. The route waypoints may be assigned Cartesian or metric coordinates, such as 3D coordinates (x, y, z translation) or 6D coordinates (x, y, z translation and rotation).

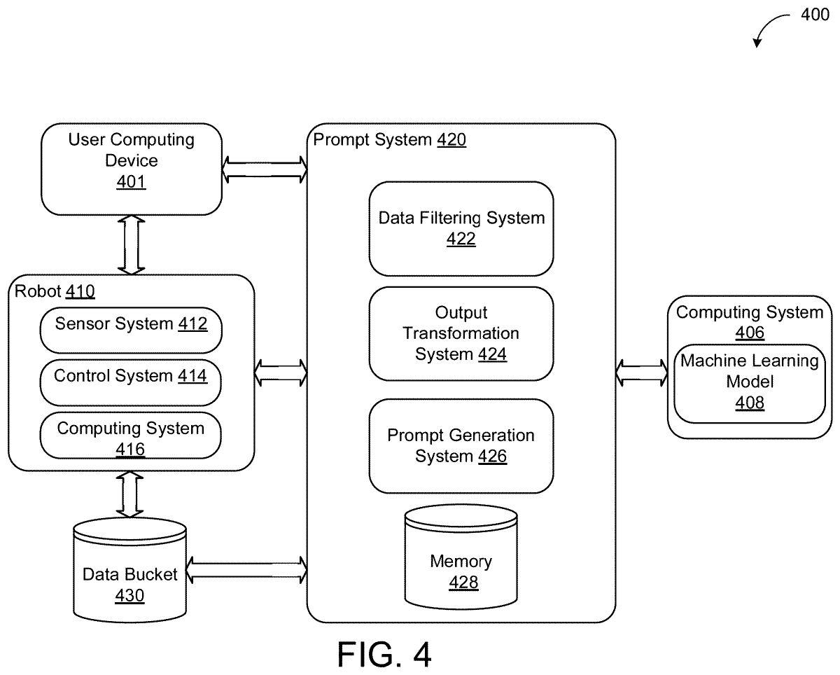

Referring now to FIG. 4, an environment 400 may include a robot 410, a user computing device 401, a prompt system 420, a computing system 406, and a data bucket 430 (e.g., a data container). All or a portion of the robot 410, the user computing device 401, the prompt system 420, and the computing system 406 may be in communication (e.g., via network) with one another (e.g., the user computing device 401 may be in communication with the robot 410). In some cases, the robot 410 may be in communication with multiple user computing devices and/or multiple prompt systems. For example, the robot 410 may be in communication with a plurality of user computing devices associated with a plurality of users. In some cases, a plurality of robots may be in communication with the user computing device 401 and/or the prompt system 420.

In some cases, the robot 410 may write sensor data to the data bucket 430. For example, the data bucket 430 may be a portion of memory (e.g., a reserved portion of data storage, virtual storage, cloud storage, etc.) that can store sensor data. The data bucket 430 may correspond to the particular parameter, as discussed herein, and may store data tagged with the particular parameter. The robot 410 may write sensor data to the data bucket 430 and the prompt system 420 and/or the user computing device 401 may obtain the sensor data from the data bucket 430.

In some cases, the robot 410 may stream sensor data. For example, the robot 410 may stream sensor data (e.g., in real time) to the prompt system 420 and/or the user computing device 401.

The prompt system 420 may be in communication with a computing system 406 that may implement a machine learning model 408. For example, the computing system 406 may be a backend server, a backend system, etc. that may provide an output in response to a prompt. Further, the machine learning model 408 may be Image-aware Decoder Enhanced a la Flamingo with Interleaved Cross-attentionS (“IDEFICS”), IDEFICS2, Chat Generative Pre-trained Transformer (“ChatGPT”), Pathways Language Model (“PaLM”), Large Language Model Meta Artificial Intelligence (“LLaMA”), etc.

As discussed herein, the computing system 406 may be a computer vision system and the computing system 406 may implement a machine learning model 408 (e.g., a visual question answering model). The machine learning model 408 may be trained to obtain an input (e.g., image data and text data) and provide an output based on the input. In some cases, the machine learning model 408 may be trained to obtain an image and a request (e.g., a question associated with the image) and provide an output (e.g., a natural language output) which includes a response to the request (e.g., an answer to the question).

In some cases, the computing system 406, the machine learning model 408, and/or the prompt system 420 may be part of, may be implemented by, and/or may be located on the robot 410. For example, the prompt system 420 may be implemented by a computing system of the robot 410.

As discussed herein with reference to FIG. 1B, the robot 410 may include a sensor system 412, a control system 414, and a computing system 416. For example, where the environment 400 includes a plurality of robots, all or a portion of the plurality of robots may include a respective sensor system, a respective control system, and/or a respective computing system. The robot 410 may include and/or may be similar to the robot 100 discussed herein with reference to FIGS. 1A and 1B.

The sensor system 412 can gather sensor data. The sensor system 412 may include a plurality of sensors (e.g., image sensors) of the robot 410 and the sensor system 412 may gather the sensor data via the plurality of sensors. The sensor system 412 may include and/or may be similar to the sensor system 130 discussed herein with reference to FIG. 1B. The sensor system 412 may provide the sensor data to other systems of the robot 410 (e.g., the control system 414).

In one example, the sensor system 412 may include a plurality of sensors (e.g., five sensors) distributed on the robot 410. For example, the sensor system 412 may include a plurality of sensors distributed across the body, one or more legs, arm, etc. of the robot 410. The plurality of sensors may include at least two different types of sensors. For example, the plurality of sensors may include lidar sensors, image sensors, ladar sensors, audio sensors, etc. and the sensor data may include lidar sensor data, image (e.g., camera) sensor data, ladar sensor data, audio data, etc.

In some cases, the sensor data may include three-dimensional point cloud data. The sensor system 412 (or a separate system) may use the three-dimensional point cloud data to detect and track features within a three-dimensional coordinate system. For example, the sensor system 412 may use the three-dimensional point cloud data to detect and track movers within the environment.

In some cases, the sensor data may include panoramic image data. For example, the sensor data may include a 360 degree representation of the environment. In some cases, the sensor system 412 may automatically and/or continuously obtain (e.g., collect) sensor data. For example, the sensor system 412 may automatically and/or continuously obtain sensor data as the robot 410 navigates within the environment.

The computing system 416 may include data processing hardware (e.g., a data processor, a hardware processor, etc.) and memory hardware. The memory hardware may store instructions and the data processing hardware may execute the instructions which may cause the data processing hardware to perform one or more operations. The computing system 416 may include and/or may be similar to the computing system 140 discussed herein with reference to FIGS. 1A and 1B.

The control system 414 may include a controller (e.g., similar to the at least one controller 172 discussed herein). The control system 414 may include and/or may be similar to the control system 170 discussed herein with reference to FIG. 1B.

The prompt system 420 may include a computing system to generate a prompt for the machine learning model 408. The prompt system 420 may include a data filtering system 422, an output transformation system 424, a prompt generation system 426, and memory 428.

For generation of the prompt, the user computing device 401 may further provide an input (e.g., a textual input) to the prompt system 420. For example, the input may indicate and/or include one or more alert parameters, one or more filter parameters, and/or one or more requests (e.g., one or more questions). Further, the input may indicate one or more requests with respect to filtered sensor data (e.g., based on the one or more filter parameters) and a manner of generating an alert (e.g., based on the one or more alert parameters).

To obtain the input for generation of the prompt, the prompt system 420 may cause display of a user interface via the user computing device 401 and may enable the user computing device 401 to provide the input via the user interface. For example, the user interface may include a section to provide an input. Based on an interaction by the user computing device 401 with the user interface, the prompt system 420 may obtain the input from the user computing device 401. In some cases, the input may correspond to a selection of one or more selectable identifiers (e.g., a selection of a particular robot, a particular fleet of robots, a particular request, a particular environment or a particular portion of the environment, etc.). In some cases, the input may correspond to a dynamic input (e.g., a user may dynamically provide a textual input.

The input may include and/or indicate one or more requests (e.g., questions). The one or more requests may include one or more open-ended questions and/or one or more close ended questions (e.g., multiple choice questions). For example, the input may include a request to provide a textual answer (e.g., a number, a percentage, a yes or no answer, etc.). Further, the input may include a request to measure a value or percentage associated with the environment, a request to identify whether the robot 410 slipped, a request to identify what the robot 410 slipped on if the robot slipped, a request to identify whether the robot 410 fell, a request to generate a pictorial representation of an environment of the robot 410, a request to sort (e.g., visually sort) and/or rank (e.g., visually rank) objects, entities, obstacles, and/or structures within the environment, etc. The input (e.g., the one or more requests) may further include and/or indicate one or more parameters. For example, the one or more requests may include a request to generate a prompt based on sensor data associated with a particular parameter (e.g., indicating that the robot 410 fell, that the robot 410 encountered a set of stairs, etc.).

The prompt system 420 may obtain the sensor data (e.g., from the sensor system 412) for generation of the prompt based on the input. The prompt system 420 may obtain the sensor data and filter the sensor data using one or more filter parameters from the input.

As the amount of sensor data to be filtered may be large (e.g., terabytes) of data and may be received in a rapid manner (e.g., a robot may include 15 or more sensors and all or a portion of the sensors may stream sensor data, in real time, to the computing system), the prompt system 420 can determine how to reduce the size of the sensor data (e.g., by filtering the sensor data using the one or more filter parameters) and generate a prompt for execution of one or more requests on the sensor data (e.g., the filtered sensor data).

As discussed herein, the prompt system 420 can generate a prompt based on the sensor data and the input. To generate the prompt, the prompt system 420 may obtain the input from the user computing device 401 and may obtain the sensor data from the data bucket. In some cases, the prompt system 420 may obtain particular sensor data based on the input (e.g., the one or more filter parameters). In some cases, the prompt system 420 may obtain sensor data and may filter the sensor data based on the input to obtain filtered sensor data. In some cases, the prompt system 420 may store the input and/or the sensor data in memory 428 (e.g., local memory of the prompt system 420).

To reduce the amount of the sensor data, the prompt system 420 may include a data filtering system 422. As discussed herein, the prompt system 420 may obtain the sensor data and provide the sensor data to the data filtering system 422.

The data filtering system 422 may filter the sensor data (e.g., using the one or more filter parameters) to obtain filtered sensor data. For example, the data filtering system 422 may filter the sensor data such that the filtered sensor data includes a first portion of the sensor data and excludes a second portion of the sensor data. In some cases, to filter the sensor data (e.g., image data), the data filtering system 422 may remove one or more images from the sensor data such that the filtered sensor data includes a first portion of the images of the sensor data and excludes a second portion of the images of the sensor data. In some cases, to filter the sensor data, the data filtering system 422 may remove a first portion of an image (e.g., an outer portion of the image, a particular object, entity, obstacle, and/or structure within the image, etc.) such that the filtered sensor data includes a second portion of the image but does not include the first portion of the image. In some cases, to filter the sensor data, the data filtering system 422 may blur (e.g., obscure) a portion of an image of the sensor data (e.g., an outer portion of the image, a particular object, entity, obstacle, and/or structure within the image, etc.) such that the filtered sensor data includes the blurred image.

The data filtering system 422 may filter the sensor data to identify a particular portion of the sensor data (e.g., sensor data associated with a particular time period, sensor data within a particular proximity of an event, etc.) based on the one or more filter parameters. For example, the data filtering system 422 may filter sensor data associated with an environment to obtain filtered sensor data that includes sensor data associated with a particular portion of the environment (e.g., a particular room), a particular time period (e.g., Jul. 6, 2023 at 12:01 PM ET to Jul. 7, 2023 at 12:00 PM ET), a particular robot (e.g., Robot XYZ123), a particular sensor (e.g., sensor 5 on RobotXYZ123), etc. In some cases, the data filtering system 422 may filter the sensor data in a parameter specific manner. For example, the data filtering system 422 may filter sensor data associated with a first parameter (e.g., indicating a fall of the robot 410) such that the filtered sensor data includes comparatively less sensor data associated with the first parameter as compared to sensor data associated with a second parameter (e.g., indicating a presence of an entity within a particular proximity of the robot 410).

In some cases, the data filtering system 422 may replace the sensor data stored in the data bucket 430 with the filtered sensor data. By replacing the sensor data stored in the data bucket 430 in such a manner, the prompt system 420 can greatly reduce the amount of sensor data stored in the data bucket 430.

The data filtering system 422 may provide the filtered sensor data to the prompt generation system 426. The prompt generation system 426 may obtain the filtered sensor data from the data filtering system 422 and the input (e.g., from the user computing device 401). The prompt generation system 426 may generate (e.g., dynamically generate) a prompt based on the filtered sensor data and the input (e.g., the one or more alert parameters and/or the one or more requests). The prompt may include sensor data (e.g., image data) and text data (e.g., natural language data). The text data may include a request based on the input. For example, the request may be a request to identify whether a ground surface is wet, a request to identify whether other robots are within the environment of the robot 410, identify whether the robot 410 performed a particular action based on the sensor data (e.g., whether the robot fell), a request to compare two or more images from the sensor data (e.g., compare characteristics of one or more entities, obstacles, objects, and/or structures indicated by the two or more images), a request to sort and/or rank two or more images, etc.

In some cases, the prompt generation system 426 may generate a visual prompt (e.g., the prompt may include image data from the sensor data that is combined with the text data). In some cases, the prompt generation system 426 may generate a prompt that includes separate visual and textual components. For example, the prompt generation system 426 may append text data (e.g., based on the input) to the sensor data to generate the prompt (e.g., may embed text data within image data of the sensor data). In another example, the prompt generation system 426 may annotate the sensor data with the text data to generate the prompt. In another example, the prompt generation system 426 may include the sensor data and the text data within the prompt (e.g., the prompt generation system 426 may combine the sensor data and the text data within the prompt).

In some cases, to generate the prompt, the prompt generation system 426 may identify first sensor data and second sensor data. For example, the first sensor data may include image data and the second sensor data may include pressure data, acceleration data, battery data (e.g., voltage data), speed data, position data, orientation data, pose data, tilt data, time data (e.g., a timestamp), temperature data, etc. The prompt generation system 426 may generate text data corresponding to all or a portion of the second sensor data. For example, the text data may include one or more fields and one or more field values based on the all or a portion of the second sensor data. In some cases, the prompt generation system 426 may append and/or annotate the image data with the text data corresponding to the all or a portion of the second sensor data. In some cases, the prompt generation system 426 may generate a prompt that includes the image data and the text data corresponding to the all or a portion of the second sensor data.

As discussed herein, the prompt generation system 426 may perform prompt engineering to generate the prompt. The prompt generation system 426 may perform prompt engineering such that the generated prompt is customized (e.g., specific) to the robot 410. For example, the prompt generation system 426 may include context data (e.g., text data) within the prompt indicating a context of the prompt (and the sensor data within the prompt) (e.g., the prompt is associated with the robot, the prompt is associated with a mobile robot, the prompt is associated with a legged robot, the prompt is associated with a robot with a particular number of sensors and/or legs, the sensor data is captured via one or more sensors of a legged robot, the sensors and/or legs of the robot have a particular placement, orientation, pose, movement, etc.).

By customizing the generated prompt to the robot 410, the prompt generation system 426 can generate a prompt that accounts for robot specific characteristics (e.g., that the sensor data may indicate one or more legs of the robot 410, that the sensor data may indicate a ground surface beneath a legged robot, that the sensor data may indicate a docking of the robot 410, that the sensor data may indicate other robots within an environment of the robot 410, that the sensor data may indicate a particular operation such as descent of one or more stairs backwards, etc.).

In some cases, the prompt generation system 426 can dynamically identify context data to add to the prompt. The prompt generation system 426 can identify context data based on the sensor data). For example, for a prompt based on sensor data, the prompt generation system 426 can identify and add context data to the prompt indicating how the robot properly docks, what the dock looks like, a component of the robot used to dock, etc. In another example, for a prompt based on sensor data, the prompt generation system 426 can identify and add context data to the prompt indicating a placement of legs of the robot, a particular sensor is to be oriented towards a ground surface during operation of the robot, etc. and may exclude context data associated with a dock of the robot. In another example, for a prompt based on sensor data, the prompt generation system 426 can identify and add context data to the prompt indicating characteristics of a dock, characteristics of another robot, etc.

The prompt system 420 may provide the generated prompt (e.g., generated by the prompt generation system 426) to the computing system 406. For example, the prompt system 420 may provide the generated prompt via a network.

Based on the prompt system 420 providing the generated prompt to the computing system 406, the computing system 406 may provide the generated prompt to the machine learning model 408. The computing system 406 may obtain an output from the machine learning model 408 based on providing the generated prompt to the machine learning model 408 and may provide the output to the prompt system 420. The output may include a response to the request (e.g., an answer to a question).

In some cases, the prompt system 420 may generate a plurality of prompts and may provide the plurality of prompts to the computing system 406. For example, the plurality of prompts may include a first prompt to compare a first image and a second image, a second prompt to compare a third image and a fourth image, etc. In another example, the plurality of prompts may include a prompt to compare a first image, a second image, a third image, a fourth image, etc.

In some cases, the prompt system 420 may iteratively generate and/or iteratively provide the one or more prompts (e.g., based on the output provided by the machine learning model 408). For example, the prompt system 420 may generate and provide to the computing system 406 a first prompt to compare a first image and a second image (e.g., a request to compare a first image associated with a first portion of an environment and a second image associated with a second portion of an environment and determine which portion of the environment and/or which image includes or indicates a larger puddle, more tools, etc.) and a second prompt to compare a third image and a fourth image (e.g., a request to compare a third image associated with a third portion of an environment and a fourth image associated with a fourth portion of an environment and determine which portion of the environment and/or which image includes or indicates a larger puddle, more tools, etc.). The prompt system 420 may receive an output from the computing system 406 indicating the comparison of the first image and the second image (e.g., that a value associated with the first image is greater than, less than, or equal to a value associated with the second image) and the comparison of the third image and the fourth image (e.g., that a value associated with the third image is greater than, less than, or equal to a value associated with the fourth image). The prompt system 420 may generate a third prompt to compare one of the first image or the second image (e.g., based on the comparison of the first image and the second image indicating that the value associated with the first image is greater than, less than, or equal to a value associated with the second image) to one of the third image or the fourth image (e.g., based on the comparison of the third image and the fourth image indicating that the value associated with the third image is greater than, less than, or equal to a value associated with the fourth image). The prompt system 420 may provide the third prompt to the computing system 406 and obtain a corresponding output.

The prompt system 420 may obtain the output(s) from the computing system 406. The prompt system 420 may provide the output(s) to the output transformation system 424 and the output transformation system 424 may transform the output(s). For example, the output transformation system 424 may transform the output(s) based on the input from the user computing device 401 (e.g., the input may include the one or more alert parameters). The output transformation system 424 may generate an alert based on the output(s) and the one or more alert parameters. In some cases, the output transformation system 424 may transform the output(s) based on the input that may include a request to generate a pictorial representation of the environment, generate a graphical representation of the output, provide image data, provide a text data response, flag data for review, generate an alert, etc. The output transformation system 424 may transform the output to generate a transformed output that may include a pictorial representation of the environment, a graphical representation of the output, image data, a text data response, a flag, an alert, etc.

In some cases, the prompt system 420 may store the output(s) and/or the transformed output in a database (e.g., in memory 428). For example, the prompt system 420 may store the output(s) and/or the transformed output and provide an indication indicating that the output(s) and/or the transformed output are stored and/or an identifier of a location where the output(s) and/or the transformed output are stored.

In some cases, the prompt system 420 may provide the output(s) and/or the transformed output to the user computing device 401 or a separate user computing device. For example, the prompt system 420 may cause display of the output(s) and/or the transformed output via a user interface of the user computing device 401. The prompt system 420 may provide the output(s) and/or the transformed output for review, annotation, etc. of corresponding sensor data.

In some cases, the prompt system 420 may provide the output(s) and/or the transformed output to the robot 410. For example, the prompt system 420 may provide the output(s) and/or the transformed output to the robot 410 and may train a machine learning model of the robot 410 (e.g., the machine learning model of the robot 410 for identifying actions for performance by the robot 410 based on sensor data) based on the output(s) and/or the transformed output. By training the machine learning model in such a manner, the prompt system 420 may improve the effectiveness of and accuracy of the output of the machine learning model.

In some cases, the prompt system 420 may provide the output(s) and/or the transformed output to the data bucket 430. For example, the prompt system 420 may store the output(s) and/or the transformed output in the data bucket 430. In some cases, the prompt system 420 may replace the sensor data stored in the data bucket 430 with the output(s) and/or the transformed output. By replacing the sensor data stored in the data bucket 430 in such a manner, the prompt system 420 can greatly reduce the amount of data stored in the data bucket 430.

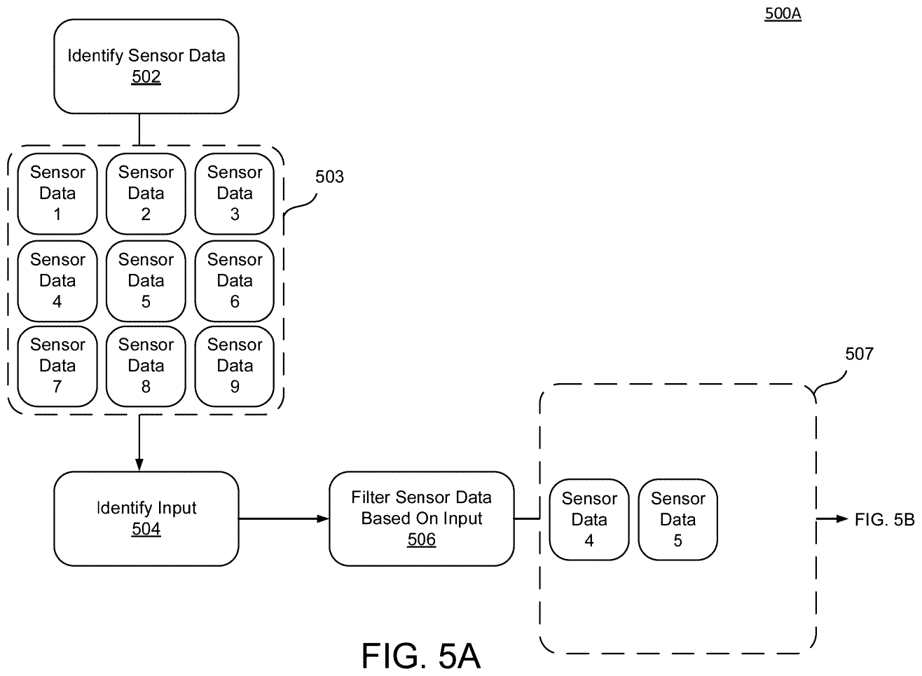

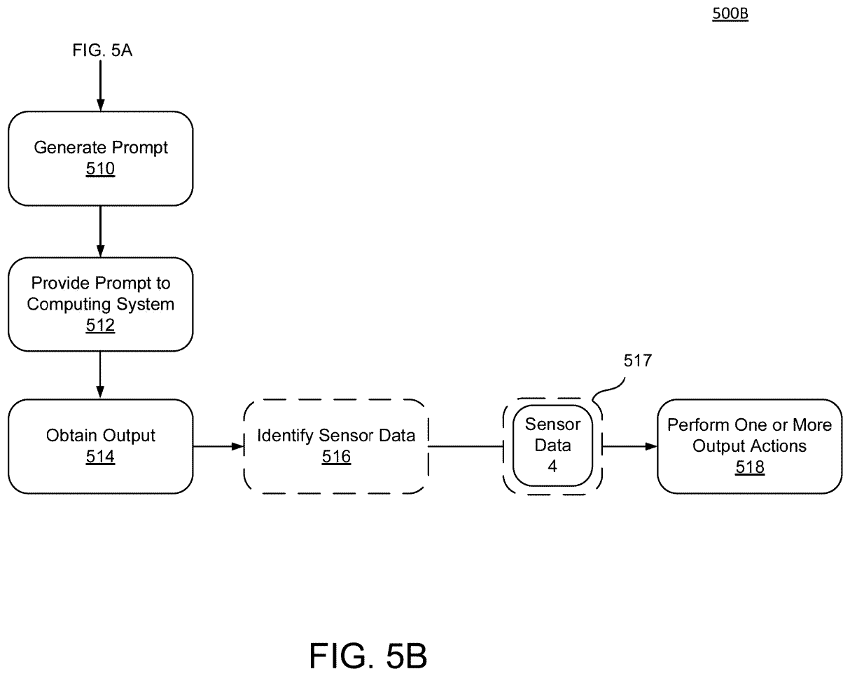

FIG. 5A and FIG. 5B are operation diagrams illustrating a data flow for filtering sensor data and performing actions based on the filtered sensor data. Any component of the robot 410 can facilitate the data flow, as discussed herein. In some embodiments, a different component can facilitate the data flow. In the example, of FIG. 5A and FIG. 5B, a computing system (e.g., the prompt system 420) facilitates the data flow.

FIG. 5A is an operation diagram 500A for filtering sensor data based on an input. The operation diagram 500A may correspond to a first portion of a step to perform one or more actions based on filtering sensor data, generating a prompt (e.g., a machine learning model prompt) based on the filtered sensor data, and receiving an output based on the prompt and the operation diagram 500B, as discussed herein with reference to FIG. 5B, may correspond to a second, subsequent portion of the step. In some examples, the first and second portions of the step may be separated by one or more intermediate steps.

At step 502, the computing system identifies sensor data 503. For example, the computing system may obtain the sensor data 503 from one or more sensors of a robot. In another example, the computing system may obtain the sensor data 503 from one or more buckets (e.g., data buckets stored by the robot).

The sensor data 503 may be grouped and/or filtered sensor data. In some cases, the computing system (or a separate system) may obtain sensor data 503 from the one or more sensors, generate parameter data (e.g., indicating one or more parameters) associated with the sensor data 503, filter and/or group the sensor data based on the parameter data to obtain filtered and/or grouped sensor data, and store the filtered and/or grouped sensor data. In some cases, the computing system (or a separate system) may tag the sensor data based on the parameter data. For example, the computing system may append a tag to a subset of the sensor data 503 based on the parameter data.

In some cases, the parameter data may include spatial context data. For example, the parameter data may indicate a location within the environment associated with the sensor data 503 (e.g., a location of the robot, a sensor of the robot, etc. when the sensor data 503 is obtained). In some cases, the spatial context data may be based on a registration of the robot within the environment.

The computing system (or a separate system) may filter and/or group the sensor data 503 based on parameter data that may include and/or indicate one or more robots associated with the sensor data 503 (e.g., the sensor data 503 was obtained via Robot #124), one or more route waypoints associated with the sensor data 503 (e.g., the sensor data 503 was obtained during navigation via a first and a second route waypoint), one or more environments associated with the sensor data 503 (e.g., the sensor data 503 was obtained during navigation in a particular environment), one or more sensors associated with the sensor data 503 (e.g., the sensor data 503 was obtained via sensor #12 and sensor #3), one or more time periods associated with the sensor data 503 (e.g., the sensor data 503 obtained between Jul. 11, 2023 at 12:01 PM ET and Jul. 11, 2023 at 12:05 PM ET), one or more environmental statuses associated with the sensor data 503 (e.g., the sensor data 503 is obtained during navigation in a school, during navigation in a crowded area, during navigation within 10 meters of a dock, etc.), one or more missions associated with the sensor data 503 (e.g., the sensor data 503 is obtained during execution of a particular mission), etc.

In the example of FIG. 5A, the sensor data 503 includes sensor data 1, sensor data 2, sensor data 3, sensor data 4, sensor data 5, sensor data 6, sensor data 7, sensor data 8, and sensor data 9. For example, the sensor data 503 may include image data obtained from one or more image sensors.

In some cases, as discussed herein, the sensor data 1, the sensor data 2, the sensor data 3, the sensor data 4, the sensor data 5, the sensor data 6, the sensor data 7, the sensor data 8, and the sensor data 9 may be filtered or grouped (e.g., according to the parameter data). For example, the computing system may obtain sensor data 503 that is grouped or filtered based on robots, route waypoints, environments, sensors, time periods, environmental statuses, missions, etc. associated with the sensor data 503 (e.g., using the parameter data).

In some cases, the sensor data 1, the sensor data 2, the sensor data 3, the sensor data 4, the sensor data 5, the sensor data 6, the sensor data 7, the sensor data 8, and the sensor data 9 may not be filtered or grouped. For example, the computing system may obtain a stream of the sensor data 503 that is not grouped or filtered.

At step 504, the computing system identifies an input. The computing system may obtain the input from a user computing device. As discussed herein, the input may include and/or may identify one or more filter parameters, one or more alert parameters, and/or one or more requests.

The one or more filter parameters may identify and/or indicate the sensor data 503 and a manner of filtering the sensor data. For example, the one or more filter parameters may indicate sensor data associated with a particular sensor (e.g., the sensor data 503) and a manner of filtering the sensor data to include a region of interest within the sensor data 503 and exclude a portion of the sensor data. In another example, the one or more filter parameters may indicate sensor data associated with a particular environment (e.g., a particular building) and manner of filtering the sensor data to include sensor data associated with a first portion of the environment (e.g., a first room within the particular building) and exclude sensor data associated with a second portion of the environment (e.g., a second room within the particular building).

The one or more requests may include one or more requests associated with the filtered sensor data. For example, the one or more requests may include a request to identify puddles within the filtered sensor data, to identify machines in need of maintenance as indicated by the filtered sensor data, to identify whether tools within the environment have been put in their place as indicated by the filtered sensor data, etc.

The one or more alert parameters may include and/or indicate one or more parameters for generating alerts. For example, the one or more alert parameters may indicate a parameter for generating an alert based on the output of a machine learning model that is provided a prompt based on the one or more filter parameters and the one or more requests. In some cases, the one or more alert parameters may indicate a manner of generating and/or displaying an output based on a prompt (e.g., for a machine learning model). For example, the one or more alert parameters may indicate that the output is to be generated by displaying the output over the sensor data 503. In another example, the one or more alert parameters may indicate that the output is to be generated as textual data. In another example, the one or more alert parameters may indicate that the output is to be displayed via a user computing device, a display of a robot, etc.

At step 506, the computing system filters the sensor data 503 based on the input. The computing system may obtain filtered sensor data 507 based on filtering the sensor data 503. As discussed herein, the computing system may filter the sensor data 503 by filtering images from the sensor data 503 (e.g., removing one or more images from the sensor data 503, removing one or more portions of one or more images from the sensor data 503, blurring one or more images and/or one or more portions of one or more images from the sensor data 503, etc.).

The computing system may filter the sensor data 503 using the one or more filter parameters (e.g., as indicated by the input). For example, the one or more filter parameters may include a parameter to filter the sensor data 503 to identify a portion of the sensor data 503 associated with a particular environment. In another example, the sensor data 503 may be pre-filtered such that the sensor data 503 is associated with a single robot and the one or more filter parameters may include a parameter to filter the sensor data 503 to identify a portion of the sensor data 503 obtained from a particular sensor of the robot.

In some cases, the one or more filter parameters may include one or more filters. The computing system may apply the one or more filters to the sensor data 503 to obtain the filtered sensor data 507.

In the example of FIG. 5A, the computing system may filter the sensor data 503 and remove sensor data 1, sensor data 2, sensor data 3, sensor data 6, sensor data 7, sensor data 8, and sensor data 9. In some cases, the computing system may filter the sensor data 503 such that the filtered sensor data 507 includes a consistent (e.g., continuous) set of sensor data. For example, the computing system may filter the sensor data 503 such that the filtered sensor data 507 includes a temporally continuous set of sensor data (e.g., sensor data is not filtered out that is temporally between sensor data to be maintained in the filtered sensor data 507).

FIG. 5B is an operation diagram 500B for performing one or more actions based on the filtered sensor data 507 and the input. At step 510, the computing system generates a prompt. The computing system may generate the prompt based on the input and the filtered sensor data 507. The prompt may include one or more images based on the filtered sensor data 507 and one or more requests in reference to the one or more images based on the input. For example, the prompt may include one or more images and a question to identify whether the environment of the robot includes one or more puddles based on the one or more images. As the prompt may be generated using the filtered sensor data 507, the amount of data sent to a machine learning model can be reduced such that the efficiency can be increased and the resource utilization (e.g., the machine learning model utilization) and the power utilization can be decreased.

The prompt may include and/or may indicate the one or more filter parameters, the one or more alert parameters, the one or more requests, and/or the filtered sensor data 507. For example, the prompt may indicate that the one or more requests are to be answered with respect to the filtered sensor data 507 and an output is to be generated according to the one or more alert parameters based on answering the one or more requests with respect to the filtered sensor data 507.

As discussed herein, the computing system may perform prompt engineering to generate the prompt. The computing system may customize the generated prompt for the robot (e.g., such that the generated prompt is customized to the robot context). For example, to customize the generated prompt for the robot, the computing system may add text data to the prompt indicating that the prompt is associated with a robot, a legged robot, a legged robot having four legs, a legged robot having four legs where segments of the four legs form openings facing towards a front portion of the robot (e.g., facing a traversal direction of the robot) and away from a rear portion of the robot, etc.

The computing system may obtain (e.g., generate) text data based on the input and sensor data (e.g., from the filtered sensor data 507, from the sensor data 503, etc.). For example, the computing system may textualize the input and the sensor data 503 to obtain the text data. In some cases, the computing system may textualize the sensor data 503 and combine the textualized sensor data with text data from the input to obtain text data.

As discussed herein, to generate the prompt, in some cases, the computing system may combine the text data and image data from the filtered sensor data 507. For example, the computing system may append the text data to images of the image data, annotate the images with the text data, etc. In another example, the prompt may include the image data from the filtered sensor data 507 with the text data appended to the image data. In some cases, the computing system may separately provide the text data and the filtered sensor data 507 within the prompt. For example, the prompt may include the text data within a first portion of the prompt and the filtered sensor data 507 within a second portion of the prompt.

At step 512, the computing system provides the prompt to a second computing system (e.g., computing system 406). For example, the computing system may provide the prompt to the second computing system via a network. The second computing system may implement a machine learning model (e.g., a visual question answering model) and the computing system may provide, to the second computing system, the prompt and a request to provide the prompt to the machine learning model.

The second computing system may provide the prompt to the machine learning model and may obtain an output from the machine learning model. In some cases, the computing system (or a system of the robot) may implement the machine learning model, may provide the prompt directly to the machine learning model, and/or may obtain the output directly from the machine learning model.

At step 514, the computing system obtains an output. The computing system may obtain the output from the second computing system (or from the machine learning model). The output may include one or more responses to the one or more requests. For example, the one or more responses may indicate that the environment includes five puddles and may indicate a location of the five puddles.

In some cases, the output may indicate a characteristic of an image, a characteristic of an object, entity, obstacle, and/or structure indicated within an image, and/or a presence of an object, entity, obstacle, and/or structure within an image (e.g., based on image processing performed on the image). For example, the one or more responses may indicate that a first image has a characteristic (e.g., a safety rating, a slipperiness, a fall danger, a safety hazard, a fire hazard, etc.). In another example, the one or more responses may indicate that an object, entity, obstacle, and/or structure within a first image has a characteristic (e.g., a corrosion, a rust level, a water level, an orientation, a pose, a heat level, a gas level, etc.). In some cases, the one or more responses may indicate that a characteristic of a first image is greater than, less than, or equal to a characteristic of a second image.

In some cases, the output may include an alert. As discussed herein, the computing system or the machine learning model may generate an alert (e.g., the computing system may generate the alert based on the one or more alert parameters). In some cases, the computing system may generate an alert based on the output (e.g., and based on the one or more alert parameters).

The computing system (or a separate system) may instruct display of the alert and/or an output based on the alert. For example, the computing system may instruct display of the alert via a user computing device.

In some cases, at step 516, the computing system may identify sensor data 517. The computing system may identify the sensor data 517 based on the output. In some cases, to identify the sensor data 517, the computing system may further filter the filtered sensor data 507 based on the output. For example, the output may indicate a portion of the filtered sensor data 507 indicates a temperature level that satisfies a threshold.

In the example of FIG. 5B, the sensor data 517 includes sensor data 4. For example, the computing system may identify sensor data 4 based on determining that sensor data 4 is associated with an environment that includes two or more robots (e.g., based on the output).

At step 518, the computing system performs one or more output actions. The computing system may perform the one or more output actions based on the output and/or the sensor data 517. In some cases, the computing system may identify the one or more output actions for performance based on the input. For example, the input may include a request to perform one or more output actions based on the output and/or the sensor data 517 (e.g., to route an alert to a particular computing device).

In some cases, as discussed herein, the one or more output actions may include an action to provide the output, the alert, and/or the sensor data 517 to a particular computing device.

In some cases, the one or more output actions may include an action to cause display of the output, the alert, and/or the sensor data 517 via the particular computing device. For example, the output may include a sorting (e.g., a visual sorting) and/or a ranking of a plurality of images from the filtered sensor data 507 and the computing system may provide the sorting and/or the ranking and/or instruct display of the sorting and/or the ranking. In another example, the computing system may generate a sorting and/or a ranking of a plurality of images from the filtered sensor data 507 based on the output and may provide the sorting and/or the ranking and/or instruct display of the sorting and/or the ranking.

In some cases, the one or more output actions may include an action to generate a graphical representation (e.g., a graph, a table, a summary, etc.) of the output, the alert, and/or the sensor data 517. For example, the one or more output actions may include an action to process the output, the alert, and/or the sensor data 517, generate a graphical representation based on processing the output, the alert, and/or the sensor data 517, and provide the graphical representation and/or cause display of the graphical representation.

In some cases, the one or more output actions may include an action to generate a pictorial representation (e.g., a digital twin) of an environment of the robot based on the output, the alert, and/or the sensor data 517. To generate the pictorial representation, the computing system may add a spatial component (e.g., a location-based component) to the filtered sensor data 507 (e.g., augment the filtered sensor data 507 with spatial data) based on the output and may generate the pictorial representation based on the addition of the spatial component to the filtered sensor data 507.

In some cases, as discussed herein, the one or more output actions may include an action to identify a portion of the pictorial representation based on the output. For example, the computing system may add an identifier to the pictorial representation indicating a particular portion of the pictorial representation (e.g., based on the input including one or more requests to indicate a portion of the environment that includes a tool on the ground, a puddle, a leak, a turned lever, etc.).

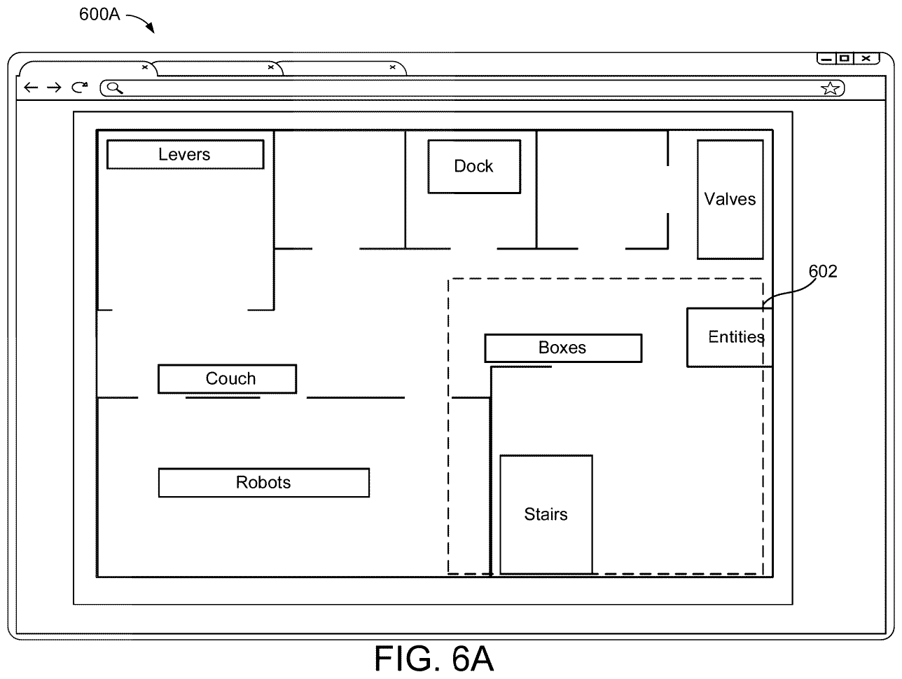

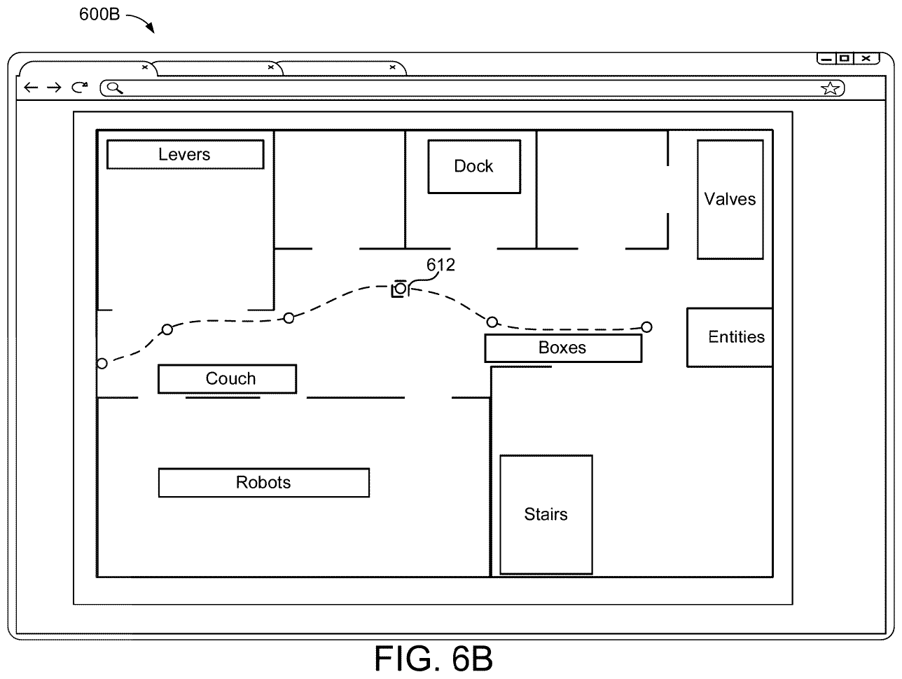

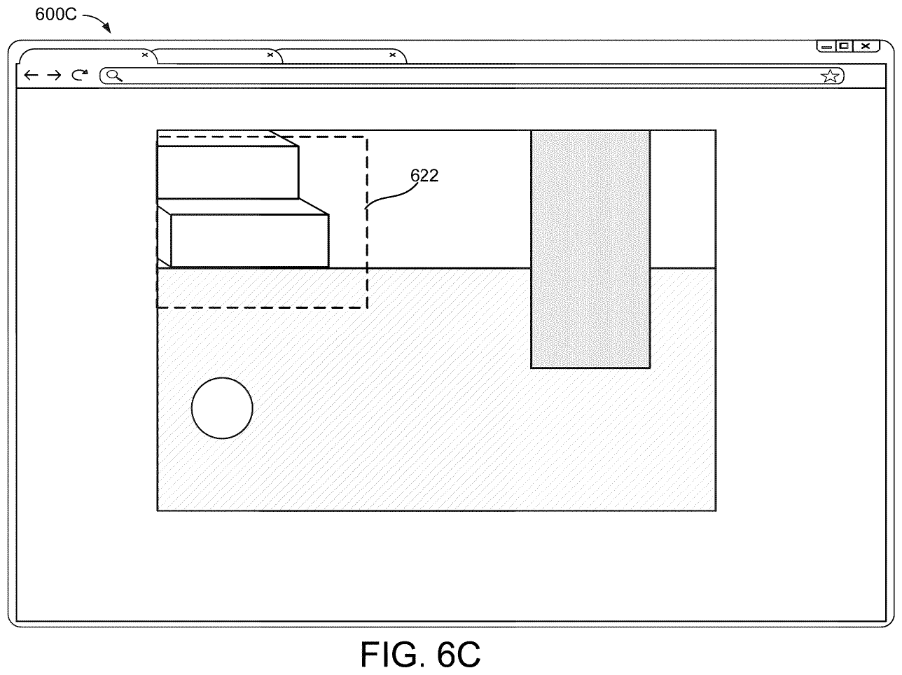

To illustrate example sensor data obtained by the prompt system and a selection of a portion of the example sensor data, FIG. 6A depicts a schematic view 600A of a selection of a portion of an environment based on provided sensor data. In some cases, a computing system (e.g., the prompt system 420) may instruct display of a virtual representation of map data (e.g., indicating an environment map, an environmental model, an obstacle map, a depth map, a ground height map, etc.) via a user interface (of a user computing device).

The map data may be based on sensor data from any sensor of the robot. For example, the robot may generate the map data (e.g., based on image sensor data indicative of an image of a scene within the environment of the robot). In another example, the robot may obtain the map data (e.g., from a user computing device, a sensor, etc.). In some cases, the robot may obtain the map data as sensor data (e.g., lidar sensor data).

The map data may indicate a plurality of objects, entities, structures, and/or obstacles in the environment of the robot. In the example of FIG. 6A, the map data indicates a ground surface, a set of spaces within the environment (e.g., rooms), levers, a couch, robots, a dock, boxes, a set of stairs, entities, and valves. It will be understood that the environment may include more, less, or different objects, entities, structures, and/or obstacles.

As discussed herein, the computing system may instruct display of the virtual representation for selection of a portion of the map data. In some cases, the computing system may identify a user associated with a robot associated with the map data (e.g., a user computing device associated with the user may be providing instructions to the robot and the robot may obtain the map data based on the instructions) and may instruct display of the virtual representation via the user computing device associated with the user for selection of a portion of the map data for the robot (or a different robot). In some cases, a first user computing device may be associated with a first user and may be providing instructions to a first robot, the first robot may obtain the map data based on the instructions, and the computing system may instruct display of the virtual representation via a second user computing device for selection of a portion of the map data for the first robot and/or a second robot.

Based on display of the virtual representation, a user computing device may provide a selection 602 of a portion of the virtual representation (e.g., via an interaction with a user interface). For example, the user computing device may provide a selection via an audio input, a click input, a textual input, a visual input, and/or any other input. In the example of FIG. 6A, the selection 602 indicates a portion of the map data that is associated with a room within the environment, the boxes, the entities, and the set of stairs.

In some cases, the computing system may receive the selection 602 as one or more filter parameters (e.g., indicating that sensor data not associated with the selection 602 is to be filtered from the sensor data for generation of the prompt). In some case, the computing system may receive the selection 602 and may generate the one or more filter parameters based on the selection 602. In some cases, the one or more filter parameters may indicate how to filter sensor data associated with one or more robots.

To illustrate example sensor data obtained by the prompt system and a selection of a portion of the example sensor data, FIG. 6B depicts a schematic view 600B of a selection of a portion of a navigation route (e.g., associated with a mission) based on provided sensor data. In some cases, a computing system (e.g., the prompt system 420) may instruct display of a virtual representation of the navigation route via a user interface (of a user computing device).

The navigation route may include one or more route edges and one or more route waypoints, where the one or more route edges connect the one or more route waypoints. The virtual representation of the navigation route may include the navigation route overlaid on map data (e.g., an environment map). In the example of FIG. 6B, the virtual representation includes a navigation route including six route waypoints and five route edges that is overlaid on map data indicating a ground surface, a set of spaces within the environment (e.g., rooms), levers, a couch, robots, a dock, boxes, a set of stairs, entities, and valves. It will be understood that the environment may include more, less, or different objects, entities, structures, and/or obstacles and the navigation route may include more, less, or different route waypoints and/or route edges.

As discussed herein, the computing system may instruct display of the virtual representation for selection of a portion of the navigation route. In some cases, the computing system may identify a user associated with a robot providing the navigation route (e.g., a robot that previously navigated according to the navigation route) and may instruct display of the virtual representation via the user computing device associated with the user for selection of a portion of the navigation route for the robot (or a different robot). In some cases, a first user computing device may be associated with a first user and may be providing instructions to a first robot, the first robot may obtain the navigation route based on the instructions, and the computing system may instruct display of the virtual representation via a second user computing device for selection of a portion of the navigation route for the first robot and/or a second robot.

Based on display of the virtual representation, a user computing device may provide a selection 612 of a portion of the virtual representation (e.g., via an interaction with a user interface). In the example of FIG. 6B, the selection 612 indicates a particular route waypoint within the navigation route.

In some cases, the computing system may receive the selection 612 as one or more filter parameters. In some case, the computing system may receive the selection 612 and may generate the one or more filter parameters based on the selection 612.

To illustrate example sensor data obtained by the prompt system and a selection of a portion of the example sensor data, FIG. 6C depicts a schematic view 600C of a selection of a portion of sensor data. In some cases, a computing system (e.g., the prompt system 420) may instruct display of a virtual representation of the sensor data via a user interface (of a user computing device).

The sensor data may include any sensor data associated with a robot. For example, the sensor data may include lidar sensor data, image sensor data, ladar sensor data, audio data, etc. In the example of FIG. 6C, the virtual representation includes image sensor data indicating a set of stairs, an object, a column, and a ground surface in an environment. It will be understood that the environment may include more, less, or different objects, entities, structures, and/or obstacles and the sensor data may indicate more, less, or different portions of the environment.

As discussed herein, the computing system may instruct display of the virtual representation for selection of a portion of the sensor data. In some cases, the computing system may identify a user associated with a robot providing the sensor data (e.g., a robot that captured the sensor data) and may instruct display of the virtual representation via the user computing device associated with the user for selection of a portion of the sensor data for the robot (or a different robot). In some cases, a first user computing device may be associated with a first user and may be providing instructions to a first robot, the first robot may obtain the sensor data based on the instructions, and the computing system may instruct display of the virtual representation via a second user computing device for selection of a portion of the sensor data for the first robot and/or a second robot.

Based on display of the virtual representation, a user computing device may provide a selection 622 of a portion of the virtual representation (e.g., via an interaction with a user interface). In the example of FIG. 6C, the selection 622 indicates a portion of the sensor data associated with a set of stairs in the environment.

In some cases, the computing system may receive the selection 622 as one or more filter parameters. In some case, the computing system may receive the selection 622 and may generate the one or more filter parameters based on the selection 622.

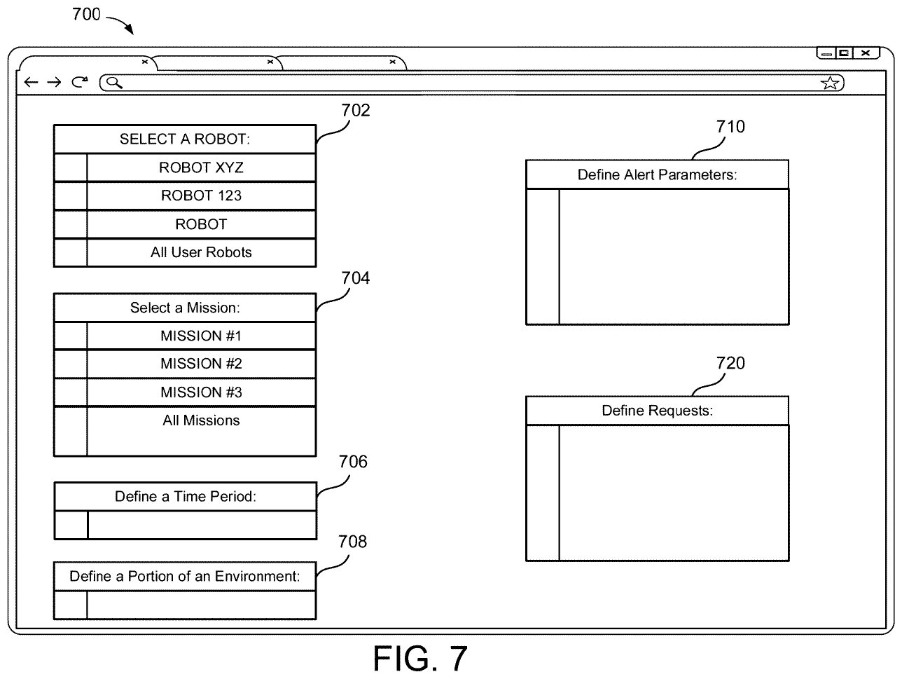

FIG. 7 is a schematic view of a user interface 700 for providing an input for generation of a prompt. A computing system (e.g., the prompt system 420) may generate and provide the user interface 700 for display via a user computing device. The computing system may generate the user interface 700 based on stored sensor data such that the user interface enables definition of one or more filter parameters, one or more alert parameters, and one or more requests. For example, the computing system may generate the user interface 700 to indicate one or more robots associated with the sensor data, one or more time periods associated with the sensor data, one or more missions associated with the sensor data, one or more portions of an environment, one or more environments, etc. for selection.

The user interface 700 may include one or more filter elements to define one or more filter parameters, one or more alert elements to define one or more alert parameters, and/or one or more request elements to define one or more requests. In the example of FIG. 7, the user interface includes a first filter element 702, a second filter element 704, a third filter element 706, a fourth filter element 708, a first alert element 710, and a first request element 720. The first filter element 702 may enable a user to select a robot to filter the sensor data, the second filter element 704 may enable the user to select one or more missions to filter the sensor data, the third filter element 706 may enable the user to define a time period to filter the sensor data, and the fourth filter element 708 may enable the user to define an environment or a portion of the environment to filter the sensor data. The first alert element 710 may enable the user to define one or more alert parameters. The first request element 720 may enable the user to define one or more requests. It will be understood that the user interface 700 may include more, less, or different elements. For example, the user interface 700 may include an element that enables a user to select a particular sensor.

Based on inputs received via one or more of the first filter element 702, the second filter element 704, the third filter element 706, the fourth filter element 708, the first alert element 710, and/or the first request element 720, the computing system can define an input for generation of a prompt. For example, the computing system can define an input indicating one or more robots, one or more requests, one or more time periods, one or more alert parameters, etc.

In the example of FIG. 7, the first filter element 702 includes the options to select “ROBOT XYZ,” “ROBOT 123,” “ROBOT,” and/or “All User Robots.” The second filter element 704 includes the options to select “Mission #1,” “Mission #2,” “Mission #3,” and/or “All Missions.” The third filter element 706, the fourth filter element 708, the first alert element 710, and the first request element 720 may enable a user to provide a free response input (e.g., a free response text data input).

In some cases, the user interface 700 may enable a user to define a threshold (e.g., a confidence threshold, an image prompt threshold, etc.), a prompt parameter (e.g., a detection parameter (e.g., a maximum, minimum, etc. number of thresholds), a lighting parameter (e.g., a parameter to equalize lighting), an annotation parameter (e.g., a parameter to annotate the sensor data), a segmentation parameter (e.g., to perform or not to perform segmentation), etc.

Based on the input, the computing system may generate a prompt (e.g., a prompt in the JSON format). In some cases, the prompt may define a format (e.g., JSON format) for responses to the prompt. In one example, the prompt may indicate “(1) is a fire extinguisher blocked? Answer True or False, (2) of the following classes, which best describes the object blocking the fire extinguisher? Select from [person, robot, vehicle, unknown], Your answer should be in the format: {“objects”: <True or False>, “object_class”: <object class>}.”

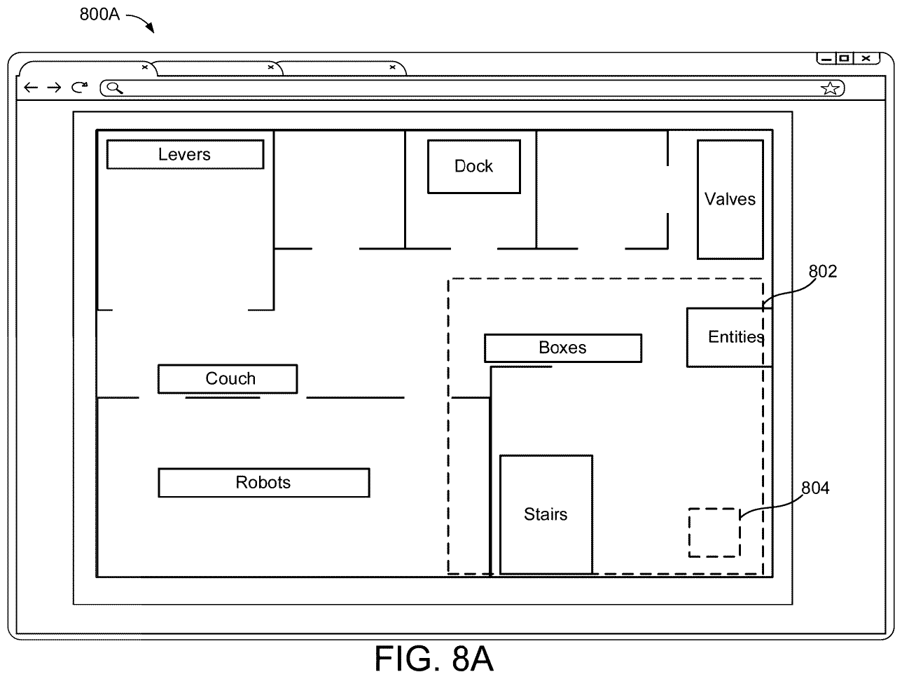

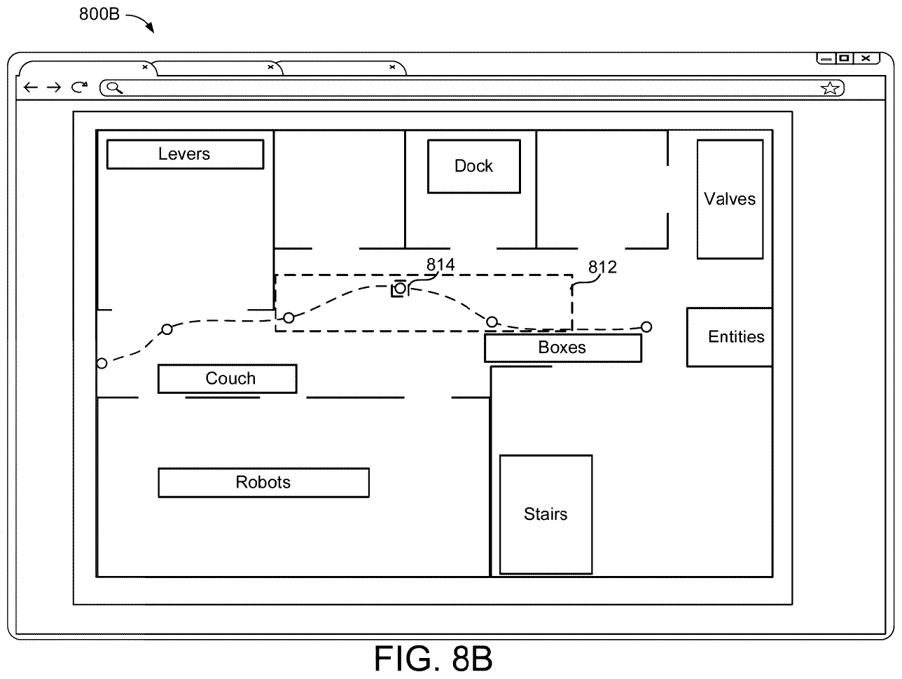

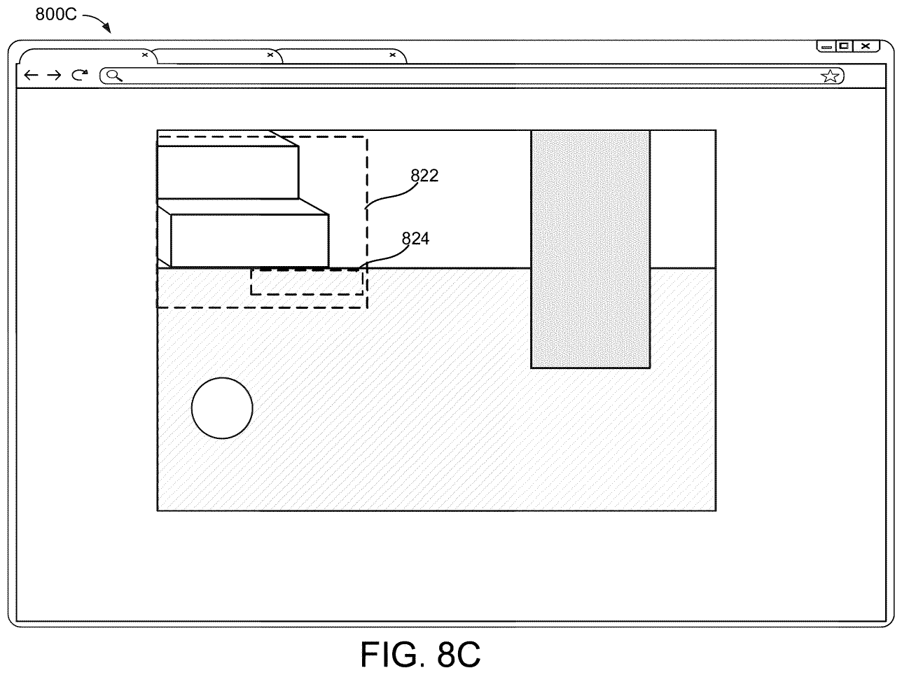

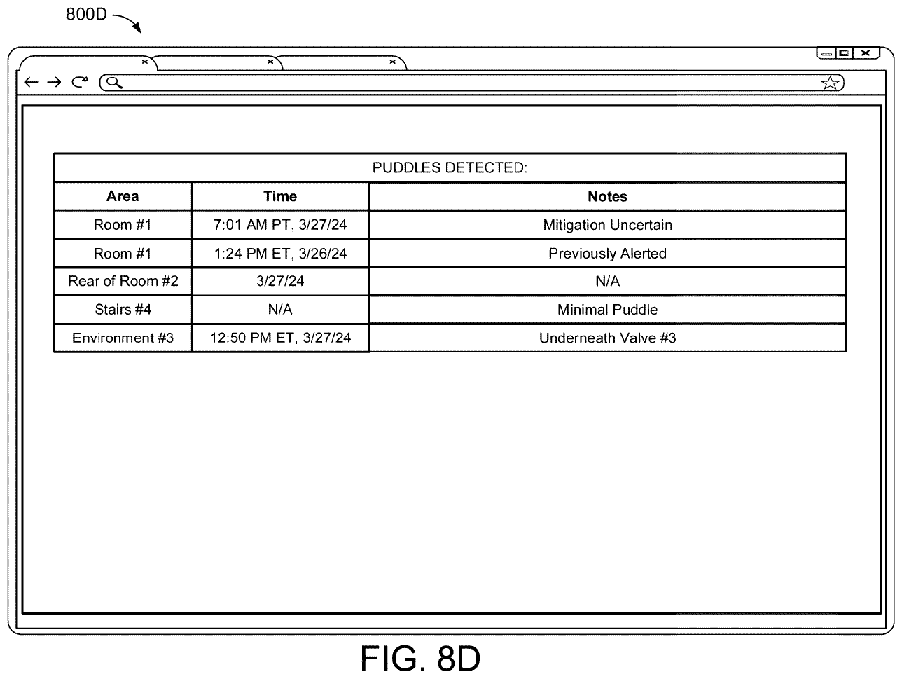

Based on generation of the prompt, provision of the prompt to a second computing system, and receipt of an output (e.g., an alert) from the second computing system based on the computing system providing the prompt to a machine learning model for implementation, as discussed herein, a computing system (e.g., the prompt system 420) may perform one or more actions. For example, the computing system may provide the output and/or a transformed output. FIG. 8A, FIG. 8B, FIG. 8C, and FIG. 8D depict schematic views of example user interfaces providing the output and/or a transformed output.

FIG. 8A is a schematic view of a first example of a user interface 800A for providing an alert (e.g., based on an implemented prompt). A computing system (e.g., the prompt system 420) may obtain an output (e.g., of a second computing system) and provide the alert based on the output. For example, the computing system may obtain the output in response to an implemented prompt. As discussed herein, the output may indicate one or more responses to a particular request (e.g., did the environment of the robot include a safety hazard?, did the environment include a fire hazard?, did the environment include a trip hazard?, Did the environment include a security hazard?, did the environment include any objects that the robot could grasp with a hand member of the robot?, did the environment include any entities (e.g., humans) within a particular time period?, where are the fire extinguishers in the environment?, etc.). In some cases, the output may include the alert (e.g., the output may indicate a number of trip hazards satisfied a threshold). In some cases, the computing system may transform the output to obtain the alert (e.g., using the one or more alert parameters).

In some cases, the computing system may instruct display of the user interface 800A based on an input received via the user interface 700. For example, the input received via the user interface 700 may indicate one or more alert parameters. In the example of FIG. 8A, the input may indicate a portion of a virtual representation of map data for monitoring, one or more alert parameters (e.g., an alert threshold), and one or more requests. In some cases, the computing system may instruct display of the user interface 800A based on transforming the output.

In the example of FIG. 8A, the user interface 800A includes a selection 802 of a portion of the virtual representation of the map data for monitoring and an alert 804 corresponding to a subset of the portion of the virtual representation of the map data (e.g., based on the one or more alert parameters, the one or more requests, and the one or more filter parameters). For example, the alert 804 may indicate that a leak is detected in the subset of the portion of the virtual representation. In some cases, the user interface 800A may not indicate the selection 802.

FIG. 8B is a schematic view of a second example of a user interface 800B for providing an alert. A computing system (e.g., the prompt system 420) may obtain an output. As discussed herein, the output may indicate one or more responses to a particular request.

In some cases, the computing system may instruct display of the user interface 800B based on an input received via the user interface 700. In the example of FIG. 8B, the input may indicate a portion of a navigation route for monitoring, one or more alert parameters (e.g., an alert threshold), and one or more requests. Further, the user interface 800B includes a selection 812 of a portion of the navigation route for monitoring (e.g., associated with three route waypoints and at least a portion of four route edges) and an alert 814 corresponding to a subset of the portion of the navigation route (e.g., associated with a particular route waypoint). For example, the alert 814 may indicate that a fire extinguisher is blocked when viewed from a particular route waypoint.

FIG. 8C is a schematic view of a third example of a user interface 800C for providing an alert. A computing system (e.g., the prompt system 420) may obtain an output. As discussed herein, the output may indicate one or more responses to a particular request.

In some cases, the computing system may instruct display of the user interface 800C based on an input received via the user interface 700. In the example of FIG. 8C, the input may indicate a portion of sensor data (e.g., image data) for monitoring, one or more alert parameters (e.g., an alert threshold), and one or more requests. Further, the user interface 800C includes a selection 822 of a portion of the sensor data for monitoring (e.g., associated with a set of stairs) and an alert 824 corresponding to a subset of the portion of the sensor data (e.g., associated with an area in front of the set of stairs). For example, the alert 824 may indicate that a safety hazard is located in front of the set of stairs.

FIG. 8D is a schematic view of a fourth example of a user interface 800D for providing an alert. A computing system (e.g., the prompt system 420) may obtain an output. As discussed herein, the output may indicate one or more responses to a particular request.

In some cases, the computing system may instruct display of the user interface 800D based on an input received via the user interface 700. The user interface 800D may include text data based on the output. In the example of FIG. 8C, the text data indicates puddles detected, an area associated with the puddles detected, a time of the puddles detected, and notes. Further, the text data indicates a first puddle is detected in “Room #1” at “7:01 AM PT, Mar. 27, 2024,” with notes indicating “Mitigation Uncertain,” a second puddle is detected in “Room #1” at “1:24 PM ET, Mar. 26, 2024,” with notes indicating “Previously Alerted,” a third puddle is detected in “Rear of Room #2” at “Mar. 27, 2024,” with notes indicating “N/A,” a fourth puddle is detected in “Stairs #4” at “N/A,” with notes indicating “Minimal Puddle,” and a fifth puddle is detected in “Environment #3” at “12:50 PM ET, Mar. 27, 2024,” with notes indicating “Underneath Valve #3.”

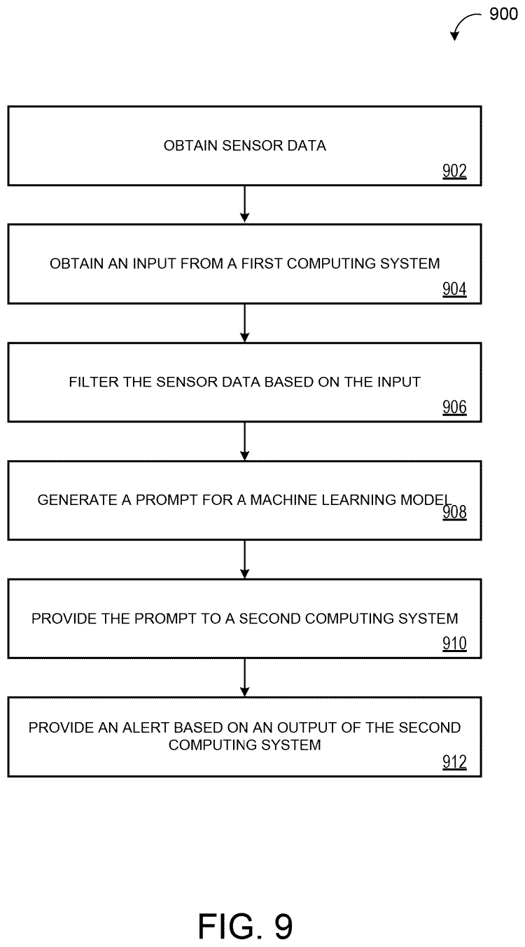

FIG. 9 is a flowchart 900 of an example arrangement of operations for providing an alert based on a generated and implemented prompt. The prompt may be generated based on sensor data associated with a robot. For example, the robot may be a legged robot with a set of legs (e.g., two or more legs, four or more legs, etc.), memory, and a processor. Further, the computing system may be a computing system of the robot. In some cases, the computing system of the robot may be located on and/or part of the robot. In some cases, the computing system of the robot may be distinct from and located remotely from the robot. For example, the computing system of the robot may communicate, via a local network, with the robot. The computing system may be similar, for example, to the prompt system 420 as discussed herein, and may include memory and/or data processing hardware.

At block 902, the computing system obtains sensor data (e.g., image data). For example, the sensor data may include panoramic image data. The sensor data may be associated with traversal of an environment by one or more mobile robots (e.g., one or more quadruped robots). In some cases, the sensor data may be associated with one or more missions of the one or more mobile robots. For example, the one or more mobile robots may traverse the environment based on the one or more missions and obtain the sensor data. In some cases, the sensor data may not be associated with traversal of the environment and may be obtained without traversing the environment.

In some cases, the computing system may obtain the sensor data from one or more sensors of the one or more mobile robots. For example, the computing system may obtain a first portion of the sensor data from a first sensor of a mobile robot of the one or more mobile robots and may obtain a second portion of the sensor data from a second sensor of the mobile robot. In another example, the computing system may obtain a first portion of the sensor data from a first sensor of a first mobile robot of the one or more mobile robots and may obtain a second portion of the sensor data from a second sensor of a second mobile robot of the one or more mobile robots.

In some cases, the computing system may instruct the one or more mobile robots to obtain the sensor data. For example, the computing system may instruct the one or more mobile robots to traverse the environment (e.g., according to a mission) and obtain the sensor data.

At block 904, the computing system obtains an input from a first computing system (e.g., a user computing device). In some cases, the computing system may instruct the one or more mobile robots to obtain the sensor data based on (e.g., in response to) obtaining an input (e.g., the input from the first computing system). The input may indicate one or more requests (e.g., one or more questions), one or more alert parameters, and/or one or more filter parameters.

The one or more requests may include requests for the sensor data (e.g., requests for monitoring the sensor data) For example, the one or more requests may include one or more questions requesting comparison (e.g., a visual comparison, a visual comparison operation, etc.) of two or more objects, entities, obstacles, and/or structures as indicated by the at least a portion of the log data. The comparison may be a comparison of characteristics of the images (e.g., a comparison of characteristics of the two or more objects, entities, obstacles, and/or structures). In some cases, the comparison may be a comparison of the same object, entity, obstacle, and/or structure but based on sensor data captured at different time periods, from different viewpoints, etc. In another example, the one or more requests may include a request to compare a first image of the log data to a second image of the log data. In another example, the one or more requests may include one or more multiple choice questions. By limiting the possible responses (e.g., answers) to a question, the computing system can improve the efficiency and accuracy of a machine learning model.

The one or more filter parameters may indicate how to filter the sensor data (e.g., a manner of filtering the sensor data). For example, the one or more filter parameters may indicate a selection of all or a portion of a mission, all or a portion of an environment, all or a portion of a set of sensor data (e.g., a region of interest, a point of view associated with the one or more mobile robots, etc.), all or a portion of one or more route waypoints, all or a portion of route edges, all or a portion of a time period, all or a portion of one or more sensors of the one or more mobile robots, all or a portion of one or more robots, all or a portion of one or more environmental statuses, all or a portion of one or more objects, entities, structures, or obstacles, all or a portion of one or more poses, orientations, locations, or positions of a robot, etc.

At block 906, the computing system filters the sensor data based on the input (e.g., using the one or more filter parameters). The computing system may filter the sensor data to obtain a filtered portion of the sensor data (e.g., filtered sensor data). In some cases, to filter the sensor data, the computing system may remove a portion of the sensor data. For example, the sensor data may include a plurality of images and the computing system may filter the sensor data by removing one or more images from the plurality of images. In another example, the sensor data may include a plurality of images and the computing system may filer the sensor data by removing a portion of an image of the plurality of images (e.g., such that the plurality of images includes a first portion of the image but excludes a second portion of the image).

In some cases, the computing system may filter the sensor data based on the input (e.g., the computing system may filter historical or stored sensor data). In some cases, the computing system may filter second sensor data based on the input (e.g., the computing system may filter streaming or future sensor data based on receipt of the sensor data).

At block 908, the computing system generates (e.g., dynamically generates) a prompt for a machine learning model (e.g., a visually question answering model and/or an object detector). The computing system may generate the prompt based on the sensor data (e.g., the filtered portion of the sensor data) and the input (e.g., text data). The prompt may include at least a portion of the filtered portion of the sensor data and the one or more requests (e.g., based on the input). For example, the prompt may include at least a portion of the filtered portion of the sensor data and one or more questions (e.g., one or more open-ended questions, one or more multiple choice questions, etc.). In another example, the prompt may include the one or more alert parameters.

In some cases, the prompt may include at least one of sensor data or synthetic image data. The computing system may generate synthetic image data based on the sensor data. The synthetic image data may include a synthetic image indicating one or more obstacles, entities, structures, or objects within an environment.

In some cases, the prompt may include context data. For example, the context data may indicate that the at least a portion of the filtered portion of the sensor data is associated with the one or more mobile robots, is associated with the one or more mobile robots that are located within a particular proximity of a ground surface (e.g., 1 meter), is associated with the one or more mobile robots traversing the environment, is associated with (e.g., generated by) one or more sensors of the one or more mobile robots, is associated with the one or more mobile robots and all or a portion of the one or more mobile robots may include two or more legs, etc.

In some cases, the one or more filter parameters may indicate a mission associated with the one or more mobile robots. The mission may be associated with one or more first mission parameters and the prompt may be associated with one or more second mission parameters. For example, the first mission parameters may indicate a first navigation route, a first robot, a first set of actions for performance, etc. and the second mission parameters may indicate a second navigation route, a second robot, a second set of actions for performance, etc.

At block 910, the computing system provides the prompt (e.g., for the machine learning model) to a second computing system. For example, the second computing system may implement the machine learning model and may provide the prompt to the machine learning model as an input (e.g., for implementation of the prompt). In some cases, the second computing system may be remote from the one or more mobile robots. In some cases, the second computing system may be a computing system of the one or more mobile robots.

In some cases, the prompt may be a prompt to provide a structured output. For example, the prompt may be a prompt to provide an output in a particular format (e.g., to provide a JSON file).

In some cases, the computing system may separately provide the text data, the context data, the input, and the at least a portion of the filtered portion of the sensor data as the prompt to the second computing system.

At block 912, the computing system provides an alert based on an output of the second computing system. The alert may be based on the one or more alert parameters. The alert may indicate a portion of the environment. For example, the alert may be a visual alert and may indicate a portion of the environment associated with the alert. In some cases, the alert may indicate anomalous behavior. For example, the alert may indicate a presence of an anomaly condition within the filtered portion of the sensor data. In some cases, the alert may indicate a quantity of an object, entity, structure, or obstacle in the environment.

The second computing system may obtain an output from the machine learning model based on providing the prompt to the machine learning model and may provid the output to the computing system. The computing system may obtain the output from the second computing system.

The output may include one or more responses to the prompt (e.g., one or more requests of the prompt). For example, where the prompt includes a request to identify one or more puddles in the environment, the one or more responses may indicate a location of one or more puddles in the environment. The one or more responses may include one or more responses in JSON format (e.g., JSON data format).

In some cases, the output may include at least one of a flag, an alert (e.g., a visual alert), a visual top K (e.g., a visual selection of K images, where K can be any number, from a set of mages based on the prompt), a ranking, a sort, etc. For example, the output may include an alert of an anomalous condition (e.g., a water leak, a fire, etc.).

In some cases, the computing system may instruct performance of one or more actions (e.g., one or more output actions) based on the output. In some cases, the one or more output actions may include routing the output, generating and/or routing an alert, and/or instructing display of the output. In some cases, the one or more output actions may include instructing movement of a robot based on the output (e.g., instructing movement of one or more legs, an arm, etc. of the robot). In some cases, the one or more output actions may include instructing a robot to obtain sensor data based on the output. In some cases, the one or more output actions may include training and/or validating a system based on the output. In some cases, the one or more output actions may include generating a second output based on the output.

In some cases, to perform the one or more output actions, the computing system may generate the alert based on the output and/or the one or more alert parameters. For example, the computing system may transform the output and generate a transformed output that includes at least one of a flag, an alert, a visual top K, a ranking, a sort, etc. In another example, the computing system may determine that a value associated with the output satisfies (e.g., is greater than or matches) a threshold based on the one or more alert parameters (e.g., the one or more alert parameters may indicate the threshold) and may generate the alert based on determining that the value satisfies the threshold.

In some cases, to perform the one or more output actions, the computing system may provide the output to a database. The computing system may provide access to the database to another computing system (e.g., the first computing system). In some cases, the computing system may provide a link to the database to another computing system (e.g., the first computing system).

In some cases, to perform the one or more output actions, the computing system may provide the output to another computing system (e.g., the first computing system). For example, the computing system may route the output to the first computing system via a network connection.

In some cases, to perform the one or more output actions, the computing system may instruct display of a user interface based on the output. For example, the user interface may include and/or may indicate the alert.

In some cases, the computing system may instruct performance of the one or more output actions by the one or more mobile robots based on the output. In another example, the computing system may instruct performance of the one or more output actions by one or more second mobile robots (e.g., different from the one or more mobile robots) based on the output.

The one or more output actions may include instructing a mobile robot (e.g., a mobile robot of the one or more mobile robots, a different mobile robot, etc.) to navigate an environment, to capture sensor data, perform an analysis, collect a sample, move an object,

By performing the one or more output actions in such a manner, the computing system can decouple actions from missions. Further, the computing system can stack or nest missions and/or stack or nest actions within a mission. For example, the computing system can nest a mission within a mission. In another example, the computing system can retroactively add an action for performance relative to sensor data associated with a mission previously conducted by a robot.

In some cases, the computing system may obtain data associated with the environment of the one or more mobile robots. For example, the data may include map data, first sensor data, a mission (e.g., a navigation route), etc. In another example, the data may be associated with the one or more mobile robots.

The computing system may instruct display of a user interface via the first computing system based on the data associated with the environment. For example, the user interface may include a virtual representation of the data (e.g., the map data, the sensor data, the mission, etc.). The computing system may obtain the sensor data and/or the input based on (e.g., in response to) instructing display of the user interface.

In some cases, the computing system may obtain the input (e.g., via the user interface) and may instruct traversal of the environment by the one or more mobile robots (e.g., subsequent to obtaining the input). The computing system may obtain the sensor data based on the traversal of the environment by the one or more mobile robots.

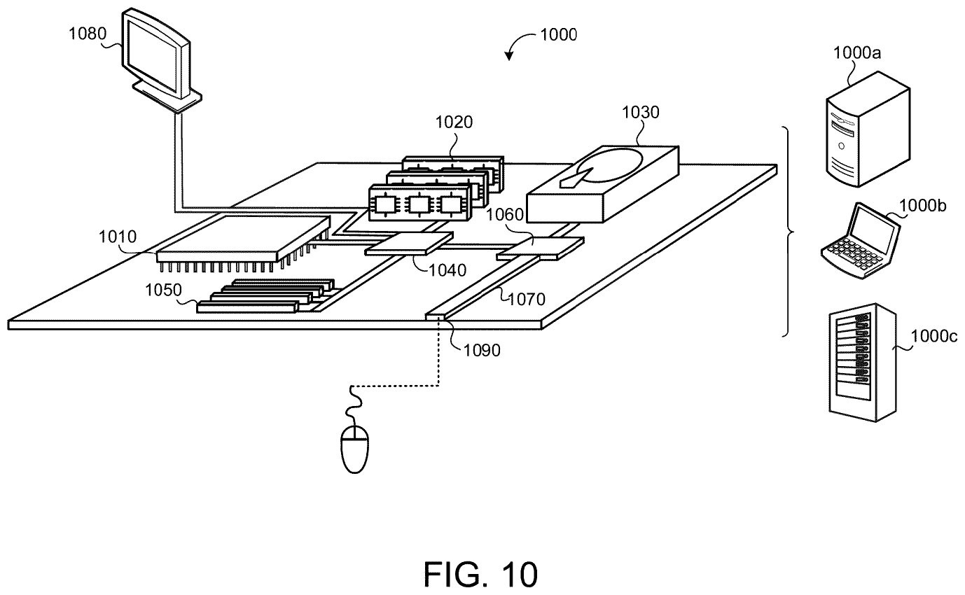

FIG. 10 is schematic view of an example computing device 1000 that may be used to implement the systems and methods described in this document. The computing device 1000 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1000 includes a processor 1010, memory 1020 (e.g., non-transitory memory), a storage device 1030, a high-speed interface/controller 1040 connecting to the memory 1020 and high-speed expansion ports 1050, and a low-speed interface/controller 1060 connecting to a low-speed bus 1070 and a storage device 1030. All or a portion of the processor 1010, the memory 1020, the storage device 1030, the high-speed interface/controller 1040, and/or the high-speed expansion ports 1050 may be interconnected using various busses, and may be mounted on a common motherboard or in other manners as appropriate. The processor 1010 can process instructions for execution within the computing device 1000, including instructions stored in the memory 1020 or on the storage device 1030 to display graphical information for a graphical user interface (GUI) on an external input/output device, such as display 1080 coupled to the high-speed interface/controller 1040. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1020 stores information non-transitorily within the computing device 1000. The memory 1020 may be a computer-readable medium, a volatile memory unit(s), or non-volatile memory unit(s). The memory 1020 may be physical devices used to store programs (e.g., sequences of instructions) or data (e.g., program state information) on a temporary or permanent basis for use by the computing device 1000. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 1030 is capable of providing mass storage for the computing device 1000. In some implementations, the storage device 1030 is a computer-readable medium. In various different implementations, the storage device 1030 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described herein. The information carrier is a computer-or machine-readable medium, such as the memory 1020, the storage device 1030, or memory on processor 1010.

The high-speed interface/controller 1040 may manage bandwidth-intensive operations for the computing device 1000, while the low-speed interface/controller 1060 may manage lower bandwidth-intensive operations. Such allocation of duties is exemplary only. In some implementations, the high-speed interface/controller 1040 may be coupled to the memory 1020, the display 1080 (e.g., through a graphics processor or accelerator), and to the high-speed expansion ports 1050, which may accept various expansion cards (not shown). In some implementations, the low-speed interface/controller 1060 may be coupled to the storage device 1030 and a low-speed expansion port 1090. The low-speed expansion port 1090, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1000a or multiple times in a group of such servers, as a laptop computer 1000b, or as part of a rack server system 1000c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user. In some cases, interaction is facilitated by a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Furthermore, the elements and acts of the various embodiments described herein can be combined to provide further embodiments. Indeed, the methods and systems described herein may be embodied in a variety of other forms; furthermore, various omissions, substitutions, and changes in the form of the methods and systems described herein may be made without departing from the spirit of the disclosure. Accordingly, other implementations are within the scope of the following claims.

What is claimed is:

1. A method comprising:
obtaining, by data processing hardware, sensor data associated with traversal of an environment by one or more mobile robots;
obtaining, by the data processing hardware from a first computing system, an input indicating one or more filter parameters;
filtering, by the data processing hardware, the sensor data based on the input to obtain a filtered portion of the sensor data;
generating, by the data processing hardware, a prompt for a machine learning model, wherein the prompt for the machine learning model comprises the filtered portion of the sensor data;
providing, by the data processing hardware to a second computing system, the prompt for the machine learning model; and
providing, by the data processing hardware to the first computing system, an alert based on an output of the second computing system, wherein the output comprises one or more responses to the prompt for the machine learning model.

2. The method of claim 1, wherein the sensor data comprises panoramic image data.

3. The method of claim 1, wherein the sensor data is associated with a mission of the one or more mobile robots.

4. The method of claim 1, wherein obtaining the sensor data comprises:
obtaining the sensor data from a sensor of the one or more mobile robots.

5. The method of claim 1, wherein obtaining the sensor data comprises:
obtaining a first portion of the sensor data from a first sensor of the one or more mobile robots; and
obtaining a second portion of the sensor data from a second sensor of the one or more mobile robots.

6. The method of claim 1, wherein the one or more filter parameters indicate a portion of the environment.

7. The method of claim 1, wherein the one or more filter parameters indicate a point of view associated with the one or more mobile robots.

8. The method of claim 1, wherein the one or more filter parameters indicate a sensor of the one or more mobile robots.

9. The method of claim 1, wherein the one or more filter parameters indicate an object within the environment.

10. The method of claim 1, wherein the one or more filter parameters indicate at least one of a route waypoint associated with the environment, a pose associated with the one or more mobile robots, a position associated with the one or more mobile robots, a time period, or a mission associated with the one or more mobile robots.

11. The method of claim 1, wherein the prompt for the machine learning model further comprises one or more multiple choice questions or one or more open-ended questions.

12. The method of claim 1, wherein the output comprises at least one of a flag, a visual sorting, a visual top K, or a ranking.

13. The method of claim 1, further comprising:
determining that at least one of text associated with the output or a value associated with the output is greater than or matches a threshold, wherein the input comprises one or more alert parameters, wherein the one or more alert parameters indicate the threshold; and
generating the alert based on determining that the at least one of the text or the value is greater than or matches the threshold.

14. The method of claim 1, wherein the alert indicates at least one of a portion of the environment, an anomalous behavior, a presence of an anomaly condition, or a quantity of an object.

15. The method of claim 1, wherein the prompt for the machine learning model indicates that the filtered portion of the sensor data is associated with the one or more mobile robots and each of the one or more mobile robots comprises two or more legs.

16. The method of claim 1, wherein the machine learning model comprises at least one of a visual question answering model or an object detector.

17. The method of claim 1, wherein the sensor data comprises a plurality of images, wherein filtering the sensor data comprises:
filtering the sensor data to at least one of remove an image from the plurality of images or remove a portion of an image of the plurality of images.

18. The method of claim 1, further comprising:
instructing performance of one or more actions by the one or more mobile robots based on the output.

19. The method of claim 1, further comprising:
instructing display of a user interface based on the output, wherein the user interface indicates the alert.

20. A system comprising:
data processing hardware; and
memory in communication with the data processing hardware, the memory storing instructions that when executed on the data processing hardware cause the data processing hardware to:
obtain sensor data associated with traversal of an environment by one or more mobile robots;
obtain, from a first computing system, an input indicating one or more filter parameters;
filter the sensor data based on the input to obtain a filtered portion of the sensor data;
generate a prompt for a machine learning model, wherein the prompt for the machine learning model comprises the filtered portion of the sensor data;
provide, to a second computing system, the prompt for the machine learning model; and
provide, to the first computing system, an alert based on an output of the second computing system, wherein the output comprises one or more responses to the prompt for the machine learning model.

21. The system of claim 20, wherein the one or more filter parameters indicate a mission associated with the one or more mobile robots, wherein the mission is associated with one or more first mission parameters, and wherein the prompt for the machine learning model is associated with one or more second mission parameters.

22. The system of claim 20, wherein the prompt for the machine learning model further comprises one or more questions requesting a comparison of at least a first image of the filtered portion of the sensor data to a second image of the filtered portion of the sensor data.

23. A mobile robot comprising:
data processing hardware; and
memory in communication with the data processing hardware, the memory storing instructions that when executed on the data processing hardware cause the data processing hardware to:
obtain sensor data associated with traversal of an environment by one or more mobile robots;
obtain, from a first computing system, an input indicating one or more filter parameters;
filter the sensor data based on the input to obtain a filtered portion of the sensor data;
generate a prompt for a machine learning model, wherein the prompt for the machine learning model comprises the filtered portion of the sensor data;
provide, to a second computing system, the prompt for the machine learning model; and
provide, to the first computing system, an alert based on an output of the second computing system, wherein the output comprises one or more responses to the prompt for the machine learning model.

24. The mobile robot of claim 23, wherein the prompt for the machine learning model further comprises one or more questions requesting a comparison of at least a first image of the filtered portion of the sensor data to a second image of the filtered portion of the sensor data, and wherein the output comprises a visual sorting of the first image and the second image.

25. The mobile robot of claim 23, wherein to filter the sensor data, execution of the instructions on the data processing hardware further causes the data processing hardware to:
filter the sensor data to remove a portion of the sensor data.
